(19) United States
(12) Patent Application Publication
(10) Pub. No.: US 2014/0348242 A1
(43) Pub. Date: Nov. 27, 2014

(54) IMAGE CODING APPARATUS, IMAGE DECODING APPARATUS, AND METHOD AND PROGRAM THEREFOR

(71) Applicants: Makoto Ohtsu, Osaka-shi (JP); Tadashi Uchiumi, Osaka-shi (JP); Yoshiya Yamamoto, Osaka-shi (JP)

(72) Inventors: Makoto Ohtsu, Osaka-shi (JP); Tadashi Uchiumi, Osaka-shi (JP); Yoshiya Yamamoto, Osaka-shi (JP)

(73) Assignee: SHARP KABUSHIKI KAISHA, Osaka-shi, Osaka (JP)

(21) Appl. No.: 14/344,677

(22) PCT Filed: Sep. 10, 2012
(86) PCT No.: PCT/JP2012/073046

§ 371 Date: Mar. 13, 2014

(30) Foreign Application Priority Data
Sep. 15, 2011 (JP) 2011-201452
Nov. 22, 2011 (JP) 2011-254631

(51) Int. Cl. H04N 19/51; H04N 13/00; H04N 19/597

(52) U.S. Cl. CPC H04N 19/00696; H04N 19/00769; H04N 13/0048; H04N 2013/0081
USPC 375/240.16

(57) ABSTRACT

In disparity-compensated prediction, the precision of prediction vectors is improved even if a prediction method different from disparity-compensated prediction is utilized for blocks around a block to be coded. An image coding apparatus (100) codes a plurality of viewpoint images captured from different viewpoints. The image coding apparatus (100) includes: an imaging-condition information coder (101) that codes information indicating a positional relationship between a subject and cameras which are set for capturing the plurality of viewpoint images; a disparity information generator (104) that generates disparity information on the basis of the information and at least one of depth images corresponding to the plurality of viewpoint images; and an image coder (106) that generates, concerning a viewpoint image to be coded, a prediction vector for a viewpoint image different from the viewpoint image to be coded, on the basis of the disparity information, and that codes the viewpoint image to be coded by using the prediction vector in accordance with an inter-view prediction coding method.

### TECHNICAL FIELD

The present invention relates to an image coding apparatus for coding an image which has been captured from multiview points, an image decoding apparatus for decoding data obtained by coding such an image, and a method and a program for coding and decoding.

### BACKGROUND ART

Examples of known video coding methods are MPEG (Moving Picture Experts Group)-2, MPEG-4, and MPEG-4 AVC (Advanced Video Coding)/H.264. In these video coding methods, a coding method, which is referred to as “motion-compensated inter-frame prediction coding”, for reducing the amount of data required for coding by utilizing the correlation between moving pictures in the time domain, is used. In motion-compensated inter-frame prediction coding, an image to be coded is divided into blocks, and a motion vector is found for each block, and then, pixel values of a block of a reference image represented by a motion vector are used for prediction. In this manner, efficient coding is implemented.

Further, as in NPL 1, in the MPEG-4 standards and the H.264/AVC standards, in order to improve the compression rate of motion vectors, prediction vectors are generated, and the difference between a motion vector and a prediction vector of a block to be coded is coded. If the prediction precision of the prediction vector is high, coding this difference value rather than directly coding the motion vector is more efficient, thereby enhancing the coding efficiency. More specifically, as shown in FIG. 16, a median value of horizontal components and that of vertical components of motion vectors (mv_a, mv_b, and mv_c) of a block (adjacent block A in FIG. 16) positioned immediately on the top side of a block to be coded, a block (adjacent block B in FIG. 16) positioned on the top right side of the block to be coded, and a block (adjacent block C in FIG. 16) positioned on the left side of the block to be coded are set to be a prediction vector of the block to be coded.

Recently, in the H.264 standards, MVC (Multiview Video Coding), which are extension standards, have been established. MVC has been established for coding multiview video constituted by a plurality of moving pictures obtained by imaging the same subject or the same background with a plurality of cameras. In this coding method, disparity-compensated prediction coding is utilized in which the amount of data required for coding is reduced by utilizing disparity vectors representing the correlation between cameras. In this case, prediction vectors generated in a manner similar to a prediction vector generating method for the above-described motion vectors are also utilized for disparity vectors detected as a result of performing disparity-compensated prediction, thereby making it possible to reduce the amount of data required for coding.

However, in motion-compensated inter-frame prediction coding, coding is performed by utilizing the correlation between moving pictures in the time domain, while in disparity-compensated prediction coding, coding is performed by utilizing the correlation between cameras. Accordingly, there is no correlation between detected motion vectors and detected disparity vectors. Thus, if a block adjacent to a block to be coded has been coded by using a coding method different from that of the block to be coded, it is not possible to utilize a motion vector or a disparity vector of the adjacent block for generating a prediction vector. In one specific example, as shown in FIG. 17(A), both of the motion-compensated inter-frame prediction method and the disparity-compensated prediction method are utilized for surrounding blocks adjacent to a block to be coded. Even if motion-compensated inter-frame prediction is performed in the state shown in FIG. 17(A), there is no motion vector that can be used for prediction in an adjacent block B, as shown in FIG. 17(B). Alternatively, even if disparity-compensated prediction is performed in the state shown in FIG. 17(A), there is no disparity vector that can be used for prediction in adjacent blocks A and C, as shown in FIG. 17(C). In a known method, an adjacent block without any vector to be utilized is replaced by a zero vector, and thus, the precision of prediction vectors is decreased. Additionally, if coding methods of adjacent blocks are all different from a prediction method for a block to be coded, the above-described problem also occurs.

In order to address this problem, PTL 1 discloses the following technique in a case in which a coding method of an adjacent block is different from that of a block to be coded. If a coding method of a block to be coded is motion-compensated inter-frame prediction coding, a motion vector of a block which is most frequently contained in a region referred to by a disparity vector of an adjacent block is used for generating a prediction vector. If a coding method of a block to be coded is disparity-compensated prediction coding, a disparity vector of a block which is most frequently contained in a region referred to by a motion vector of an adjacent block is used for generating a prediction vector. With this technique, the precision in generating prediction vectors is improved.

Currently, in MPEG-3DV, which is an MPEG ad-hoc group, new standards are being established in which, in addition to moving pictures captured by a camera, a depth image is also transmitted.

A depth image is information indicating a distance from a camera to a subject. As a generation method for such a depth image, it may be obtained by a distance measuring device installed in the vicinity of a camera. Alternatively, a depth image may be generated by analyzing images captured by multiview cameras.

An overall diagram illustrating a system based on the new standards of MPEG-3DV is shown in FIG. 18. The new standards support multiple views, that is, two or more views, and the system shown in FIG. 18 which supports two views will be discussed. In this system, a subject 901 is imaged by cameras 902 and 904 and images are output. At the same time, depth images (depth maps) are generated and output by sensors 903 and 905, which measure a distance to a subject, disposed in the vicinity of the respective cameras. Upon receiving the images and depth images as an input, a coder 906 codes the images and depth images by using motion-compensated inter-frame prediction coding or disparity-compensated prediction, and then outputs the coded images and the coded depth images. Upon receiving output results of the coder 906 transmitted via a local transmission line or a network N as an input, a decoder 907 decodes the images and depth images and outputs the decoded images and the decoded depth images. Upon receiving the decoded images and the decoded depth images as an input, a display unit 908 displays the decoded images. Alternatively, the display unit 908 performs processing on the decoded images by using the depth images, and then displays the decoded images.

### CITATION LIST

### Patent Literature

PTL 1: International Publication No. 2008/053746

### Pamphlet

### Non Patent Literature

NPL 1: “H.264/AVC Textbook (H.264/AVC Kyokasho)” by Sakae Ohkubo (general editor) and Shinya Kadono, Yoshihiro Kikuchi, and Teruhiko Suzuki (co-editors), 3rd Revised Edition, Impress R&D, Jan. 1, 2009, PP. 123-125 (Motion Vector Prediction)

### SUMMARY OF INVENTION

### Technical Problem

However, in the disparity-compensated prediction technique disclosed in PTL 1, compensating for an adjacent block without any disparity vector by a disparity vector in a region referred to by a motion vector presents the following problems. In a first place, there may be a case in which a region referred to by a motion vector is not necessarily a region coded by the disparity-compensated prediction method, and a disparity vector which will replace a motion vector is not obtained. In a second place, even if a region referred to by a motion vector has been coded by the disparity-compensated prediction method, the time domain of a frame referred to by a motion vector is different from that of a frame to be coded. Accordingly, if, for example, a subject moves closer to or away from a camera, an obtained disparity vector is different from an intended disparity vector even for the same subject. Both in the first and second cases, incorrect disparity vectors are used for prediction, and thus, the precision of prediction vectors is decreased. In MPEG-3DV, too, it is necessary to solve such a problem.

The present invention has been made in view of this background. It is an object of the present invention to provide an image coding apparatus, an image decoding apparatus, a method and a program for coding and decoding in which, in disparity-compensated prediction, even if a prediction method different from disparity-compensated prediction is utilized for blocks around a block to be coded, the precision of prediction vectors can be improved.

### Solution to Problem

In order to solve the above-described problem, there is provided first technical means of the present invention. The first technical means of the present invention is an image coding apparatus for coding a plurality of viewpoint images captured from different viewpoints. The image coding apparatus includes: an information coder that codes information indicating a positional relationship between a subject and cameras which are set for capturing the plurality of viewpoint images; a disparity information generator that generates disparity information on the basis of the information and at least one of depth images corresponding to the plurality of viewpoint images; and an image coder that generates, concerning a viewpoint image to be coded, a prediction vector for a viewpoint image different from the viewpoint image to be coded, on the basis of the disparity information, and that codes the viewpoint image to be coded by using the prediction vector in accordance with an inter-view prediction coding method.

In second technical means according to the first technical means, the disparity information generator may calculate an inter-camera distance and an imaging distance from the information.

In third technical means according to the first or second technical means, the disparity information generator may generate the disparity information by calculating the disparity information on the basis of a representative value of depth values of each of blocks divided from the depth image.

In fourth technical means according to the third technical means, the disparity information generator may utilize, as the representative value, a largest value of the depth values of each of the blocks divided from the depth image.

In fifth technical means according to one of the first through fourth technical means, as a generation method for a prediction vector in the image coder, among surrounding blocks adjacent to a block to be coded which are utilized for generating the prediction vector, information based on the disparity information may be applied to a block from which it is not possible to obtain information required for generating the prediction vector.

In sixth technical means according to one of the first through fourth technical means, as a generation method for a prediction vector in the image coder, a depth image corresponding to an image to be coded may be utilized.

Seventh technical means according to one of the first through sixth technical means may further include: a depth image coder that codes the depth image.

Eighth technical means is an image decoding apparatus for decoding a plurality of viewpoint images captured from different viewpoints. The image decoding apparatus includes: an information decoder that decodes information indicating a positional relationship between a subject and cameras which have been set for capturing the plurality of viewpoint images; a disparity information generator that generates disparity information on the basis of the information and at least one of depth images corresponding to the plurality of viewpoint images; and an image decoder that generates, concerning a viewpoint image to be decoded, a prediction vector for a viewpoint image different from the viewpoint image to be decoded, on the basis of the disparity information, and that decodes the viewpoint image to be decoded by using the prediction vector in accordance with an inter-view prediction decoding method.

In ninth technical means according to the eighth technical means, the disparity information generator may calculate an inter-camera distance and an imaging distance from the information.

In tenth technical means according to the eighth or ninth technical means, the disparity information generator may generate the disparity information by calculating the disparity information on the basis of a representative value of depth values of each of blocks divided from the depth image.

In eleventh technical means according to the tenth technical means, the disparity information generator may utilize, as the representative value, a largest value of the depth values of each of the blocks divided from the depth image.

In twelfth technical means according to one of the eighth through eleventh technical means, as a generation method for a prediction vector in the image decoder, among surrounding blocks adjacent to a block to be decoded which are utilized for generating the prediction vector, information based on the disparity information may be applied to a block from which it is not possible to obtain information required for generating the prediction vector.

In thirteenth technical means according to one of the eighth through eleventh technical means, as a generation method for a prediction vector in the image decoder, a depth image corresponding to an image to be decoded may be utilized.

In fourteenth technical means according to one of the eighth through thirteenth technical means, the depth image may be coded, and the image decoding apparatus may further include a depth image decoder that decodes the depth image.

Fifteenth technical means is an image coding method for coding a plurality of viewpoint images captured from different viewpoints. The image coding method includes: a step of coding, by an information coder, information indicating a positional relationship between a subject and cameras which are set for capturing the plurality of viewpoint images; a step of generating, by a disparity information generator, disparity information on the basis of the information and at least one of depth images corresponding to the plurality of viewpoint images; and a step of generating, by an image coder, concerning a viewpoint image to be coded, a prediction vector for a viewpoint image different from the viewpoint image to be coded, on the basis of the disparity information, and coding the viewpoint image to be coded by using the prediction vector in accordance with an inter-view prediction coding method.

Sixteenth technical means is an image decoding method for decoding a plurality of viewpoint images captured from different viewpoints. The image decoding method includes: a step of decoding, by an information decoder, information indicating a positional relationship between a subject and cameras which have been set for capturing the plurality of viewpoint images; a step of generating, by a disparity information generator, disparity information on the basis of the information and at least one of depth images corresponding to the plurality of viewpoint images; and a step of generating, by an image decoder, concerning a viewpoint image to be decoded, a prediction vector for a viewpoint image different from the viewpoint image to be decoded, on the basis of the disparity information, and decoding the viewpoint image to be decoded by using the prediction vector in accordance with an inter-view prediction decoding method.

Seventeenth technical means is a program for causing a computer to execute image coding processing for coding a plurality of viewpoint images captured from different viewpoints. The program causes the computer to execute: a step of coding information indicating a positional relationship between a subject and cameras which are set for capturing the plurality of viewpoint images; a step of generating disparity information on the basis of the information and at least one of depth images corresponding to the plurality of viewpoint images; and a step of generating, concerning a viewpoint image to be coded, a prediction vector for a viewpoint image different from the viewpoint image to be coded, on the basis of the disparity information, and coding the viewpoint image to be coded by using the prediction vector in accordance with an inter-view prediction coding method.

Eighteenth technical means is a program for causing a computer to execute image decoding processing for decoding a plurality of viewpoint images captured from different viewpoints. The program causes the computer to execute: a step of decoding information indicating a positional relationship between a subject and cameras which have been set for capturing the plurality of viewpoint images; a step of generating disparity information on the basis of the information and at least one of depth images corresponding to the plurality of viewpoint images; and a step of generating, concerning a viewpoint image to be decoded, a prediction vector for a viewpoint image different from the viewpoint image to be decoded, on the basis of the disparity information, and decoding the viewpoint image to be decoded by using the prediction vector in accordance with an inter-view prediction decoding method.

### Advantageous Effects of Invention

As described above, according to the present invention, in disparity-compensated prediction, a prediction vector is generated on the basis of disparity information (that is, a disparity vector) calculated from a depth image.

Accordingly, even if a prediction method different from disparity-compensated prediction is utilized for blocks around a block to be coded, the precision of prediction vectors can be improved, thereby making it possible to enhance the coding efficiency.

### BRIEF DESCRIPTION OF DRAWINGS

FIG. 1 is a block diagram illustrating an example of the configuration of an image coding apparatus according to the present invention.

FIG. 2 is a block diagram illustrating the configuration of a disparity information generator.

FIG. 3 is a block diagram illustrating the configuration of an image coder.

FIG. 4 shows conceptual views and graph illustrating determining processing for a representative depth value.

FIG. 5 is a conceptual diagram illustrating the relationship between a depth value and a disparity value.

FIG. 6 illustrates the relationship between the imaging distance and the focal length of cameras according to the parallel viewing imaging method and that of the cross viewing imaging method.

FIG. 7 is a flowchart illustrating image coding processing performed by the image coding apparatus.

FIG. 8 is a flowchart illustrating disparity information generating processing executed by the disparity information generator.

FIG. 9 is a flowchart illustrating image coding processing performed by the image coder.

FIG. 10 is a flowchart illustrating inter-frame prediction processing performed by an inter-frame prediction unit.

FIG. 11 is a block diagram illustrating an example of the configuration of an image decoding apparatus according to the present invention.

FIG. 12 is a block diagram illustrating the configuration of an image decoder.

FIG. 13 is a flowchart illustrating image decoding processing performed by the image decoding apparatus.

FIG. 14 is a flowchart illustrating image decoding processing performed by the image decoder.

FIG. 15 is a flowchart illustrating inter-frame prediction processing performed by an inter-frame prediction unit.

FIG. 16 illustrates an example of a prediction vector generating method.

FIG. 17 illustrates a problem of a known prediction vector generating method.

FIG. 18 illustrates an overall system based on the new standards of MPEG-3DV.

FIG. 19 illustrates another example of a prediction vector generating method.

### DESCRIPTION OF EMBODIMENTS

In a video coding method (a typical example is MVC, which is an extension of H.264/AVC) in which the amount of information is reduced by performing inter-frame prediction by considering the redundancy of images having different views, if disparity-compensated prediction, which is utilized for a block to be coded, is also utilized for a block adjacent to the block to be coded, a prediction vector is generated by using a disparity vector of this adjacent block. In the present invention, MPEG-3DV, which is a next-generation video coding method, is assumed. By the use of depth image information provided as input information, even if a prediction method different from disparity-compensated prediction is utilized for a block adjacent to a block to be coded, disparity information calculated from the depth image information, that is, a disparity vector, is utilized. As a result, the prediction precision of prediction vectors is improved, thereby making it possible to obtain excellent coding efficiency by solving the problem of the related art.

Details of the present invention will be described below with reference to the drawings. In the drawings, elements having the same functions are designated by like reference numerals, and an explanation of elements having the same function will be given only once.

### First Embodiment

### Coding Apparatus

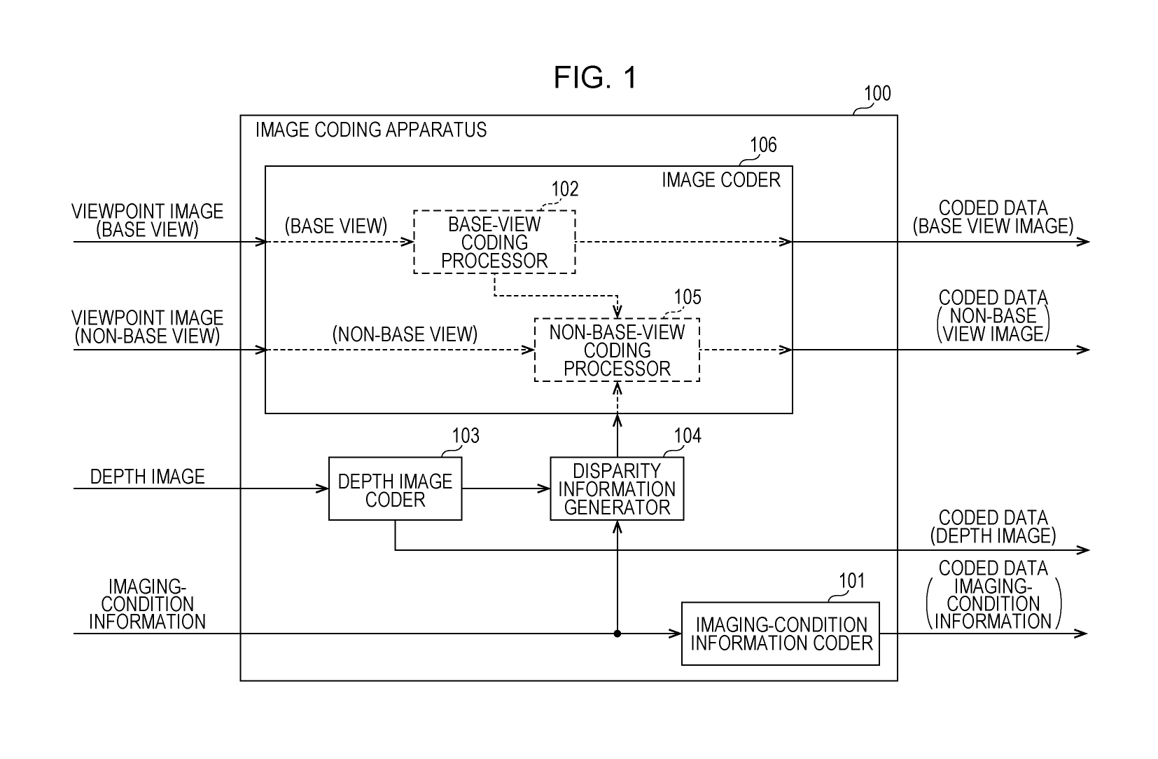

FIG. 1 is a functional block diagram illustrating an example of the configuration of an image coding apparatus, which is an embodiment of the present invention.

An image coding apparatus 100 includes an imaging-condition information coder 101, a depth image coder 103, a disparity information generator 104, and an image coder 106. Blocks shown within the image coder 106 are utilized for explaining the operation of the image coder 106 in a conceptual sense.

The function and the operation of the image coding apparatus 100 will be described below.

Data input into the image coding apparatus 100 includes a base view image, a non-base view image, a depth image, and imaging-condition information. A base view image is restricted to an image of a single viewpoint. However, as a non-base view image, a plurality of images of multiple views may be input. As a depth image, a single depth image corresponding to a viewpoint image may be input, or a plurality of depth images corresponding to all of viewpoint images may be input. If a single depth image corresponding to a viewpoint image is input, it may be a base view image or a non-base view image. Each of viewpoint images and depth images may be a still image or a moving picture. The imaging-condition information corresponds to a depth image.

A base-view coding processor 102 performs compression coding on a base view image by using an intra-view prediction coding method. In intra-view prediction coding, by performing intra-frame prediction or motion compensation within the same viewpoint, image data is subjected to compression coding on the basis of only intra-view image data. At the same time, by performing reverse processing of coding, that is, decoding, on the coded base view image, an image signal is reconstructed as a reference image for coding a non-base view image, which will be discussed later.

The depth image coder 103 compresses a depth image according to, for example, the H.264 method, which is a known method. If multiview depth images corresponding to viewpoint images are input into the depth image coder 103, compression coding may be performed on the depth images by using the above-described MVC method. At the same time, by performing reverse processing of coding, that is, decoding, on the coded depth image, a depth image signal is reconstructed to be utilized for generating disparity information, which will be discussed later. That is, the image coding apparatus 100 of this embodiment includes a depth image decoder for decoding a depth image coded by the depth image coder 103. However, since a depth image decoder is usually disposed within the depth image coder 103, the depth image coder 103 containing a depth image decoder therein is shown, and the depth image decoder itself is not shown. In a configuration in which a depth image is coded (lossy coding) and sent, when performing coding, data which will be obtained when the coded data is decoded is required to be reproduced. Accordingly, it is necessary to dispose a depth image decoder within the depth image coder 103.

A description will be given, assuming that a depth image decoder is included in the image coding apparatus 100. However, since the amount of depth image data is smaller than that of normal image data, it may be possible that a depth image is sent as raw data or that lossless coding is performed on a depth image. In such a configuration, it is possible for an image decoding apparatus to obtain original data, and thus, it is not necessary to decode a coded depth image within the depth image coder 103 when performing coding. In this manner, a configuration in which a depth image decoder is not provided in the image coding apparatus 100 may be possible. Moreover, if raw data is sent from the image coding apparatus 100 to an image decoding apparatus, the depth image coder 103 does not have to be provided since a depth image can be sent to the image decoding apparatus as long as the image decoding apparatus is capable of obtaining the depth image. In this manner, a configuration in which the depth image coder 103 and a depth image decoder are not provided in the image coding apparatus 100 may be possible.

The disparity information generator 104 generates disparity information on the basis of a reconstructed depth image and imaging-condition information input from the outside of the image coding apparatus 100. In this case, the disparity information generator 104 may simply generate disparity information indicating a disparity between a viewpoint image to be coded and a different viewpoint image. Details of such a generation method for disparity information will be discussed later. However, disparity information is not restricted to such a relative value. For example, for each of multiview images, a disparity value from a certain reference value may be calculated for each block and may be used as disparity information. As a matter of fact, since disparity information is used for generating prediction vectors, which will be discussed later, a generation method for prediction vectors is changed such that it may match the type of disparity information.

A non-base-view coding processor 105 performs compression coding on a non-base view image by using an inter-view prediction coding method, on the basis of a reconstructed base view image and generated disparity information. In the inter-view prediction coding method, disparity compensation is performed by using an image of a view different from that of an image to be coded, thereby performing compression coding on image data. The non-base-view coding processor 105 may select the intra-view prediction coding method using only intra-view image data depending on the coding efficiency.

In this embodiment, an example in which only a non-base view image is coded by using the inter-view prediction coding method will be discussed. However, both of a base view image and a non-base view image may be coded by using the inter-view prediction coding method. Alternatively, the inter-view prediction coding method and the intra-view prediction coding method may be switched for both of a base view image and a non-base view image, depending on the coding efficiency. In this case, by sending information indicating a prediction coding method from the image coding apparatus 100 to an image decoding apparatus, the image decoding apparatus is able to perform decoding.

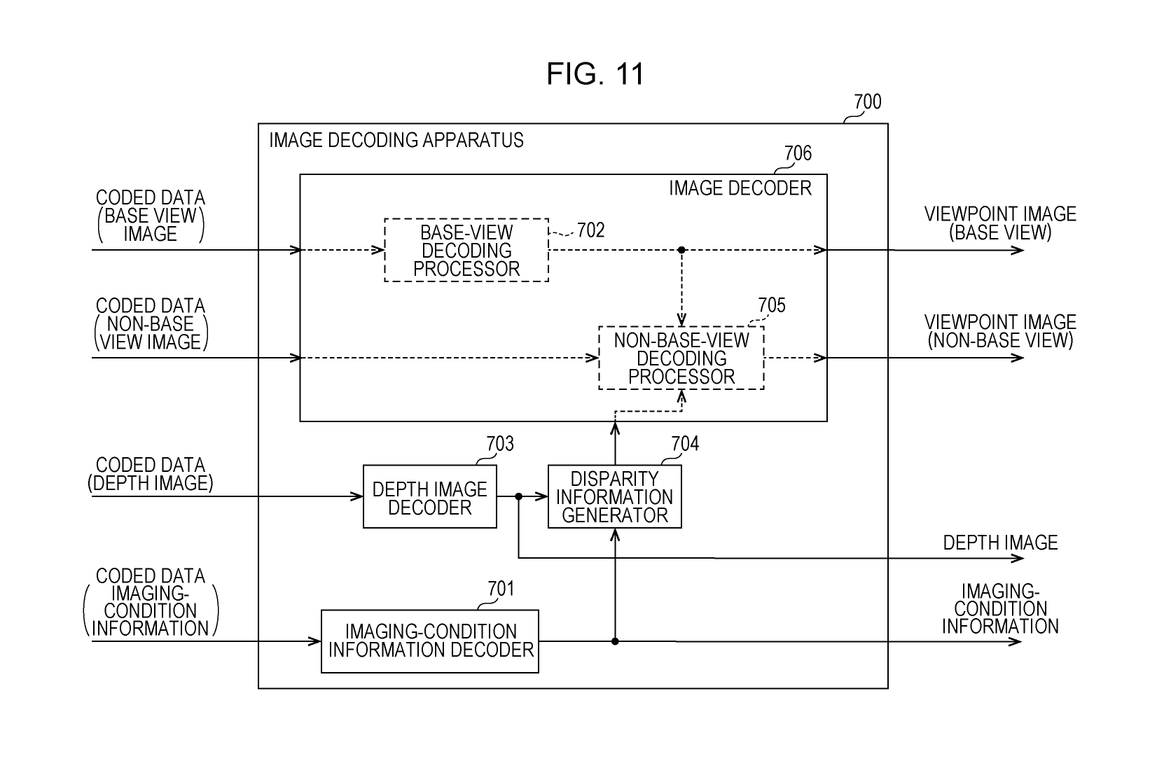

The imaging-condition information coder 101 is an example of an information coder for coding information indicating positional relationships between a subject and cameras which were set when multiview images were captured. Hereinafter, this information will be referred to as imaging-condition information. However, this information is only part of imaging-condition information, and thus, not all items of actual imaging-condition information have to be coded. The imaging-condition information coder 101 performs coding processing for converting imaging-condition information, which indicates conditions when multiview images are captured, into a predetermined code. Ultimately, items of coded data indicating a base view image, a non-base view image, a depth image, and imaging-condition information are interconnected and rearranged by a code constructing unit (not shown), and are output to the outside (for example, to an image decoding apparatus 700, which will be discussed later with reference to FIG. 11) of the image coding apparatus 100 as a coded stream.

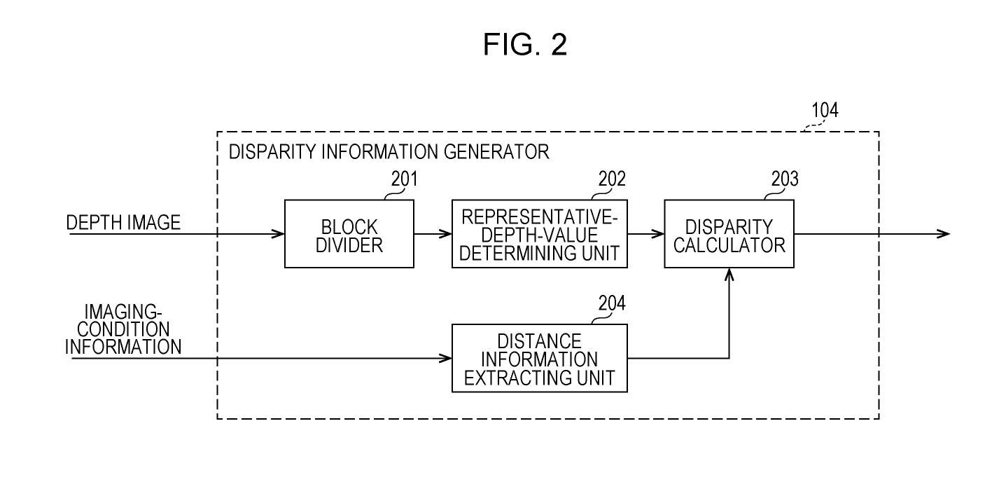

Internal processing of the disparity information generator 104 will be described below in detail with reference to FIGS. 2 and 4 through 6.

FIG. 2 is a functional block diagram illustrating the internal configuration of the disparity information generator 104. The disparity information generator 104 includes a block divider 201, a representative-depth-value determining unit 202, a disparity calculator 203, and a distance information extracting unit 204.

The block divider 201 divides an input depth image into blocks having a predetermined size (for example, 16×16 pixels). The representative-depth-value determining unit 202 determines a representative value of depth values for each of the divided blocks. More specifically, the representative-depth-value determining unit 202 creates a frequency distribution (histogram) of depth values within each block, and extracts a depth value which appears most frequently. The representative-depth-value determining unit 202 determines the extracted depth value to be a representative depth value.

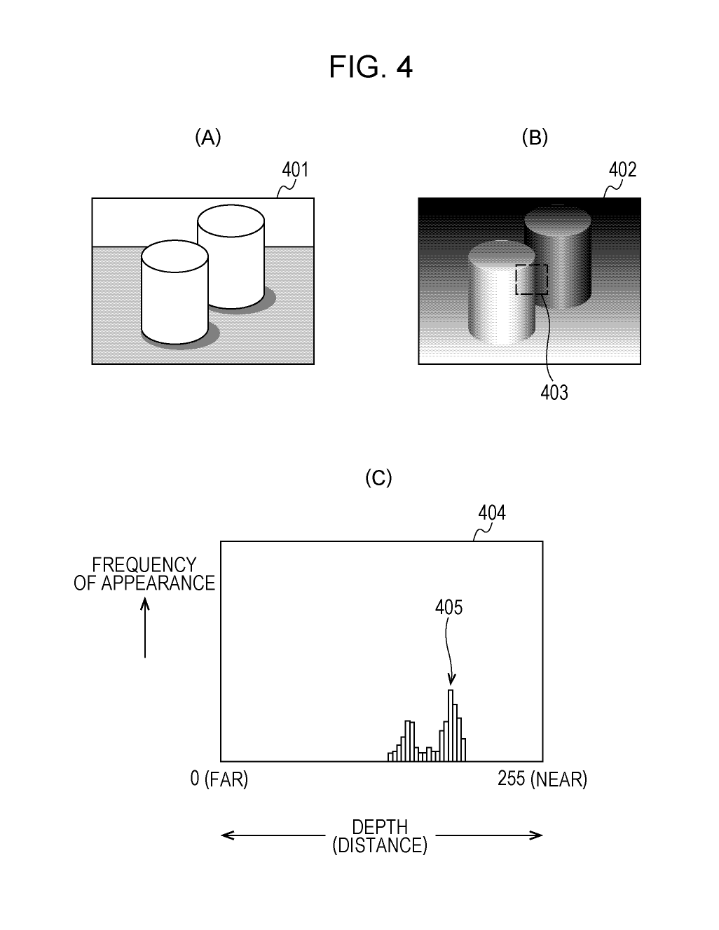

FIG. 4 shows conceptual views and graph illustrating determining processing for a representative depth value. It is assumed that, as shown in FIG. 4(B) by way of example, a depth image 402 corresponding to a viewpoint image 401, which is shown in FIG. 4(A) by way of example, is provided. A depth image is shown as a monochrome image represented only by the luminance. In a region having a higher luminance level (which means that the depth value is greater), the distance from a camera to such a region is closer. In a region having a lower luminance level (which means that the depth value is smaller), the distance from a camera to such a region is farther. In a block 403 divided from the depth image 402, it is assumed that depth values are represented by a frequency distribution, such as a frequency distribution 404 shown in FIG. 4(C) by way of example. In this case, a depth value 405 which appears most frequently is determined to be a representative depth value of the block 403.

Instead of the above-described method using a histogram, the representative depth value may be determined by the following methods. For example, concerning depth values within a block, (a) a median value, (b) an average value considering the frequency of appearance, (c) a value of the depth representing the closest distance from a camera (the largest depth value within a block), (d) a value of the depth representing the farthest distance from a camera (the smallest depth value within a block), or (e) a depth value positioned at the center of a block may be extracted and determined to be a representative depth value. As a basis of selecting which of the methods to be utilized, for example, the most efficient method may be selected and fixed for both coding and decoding. Alternatively, on the basis of the above-described methods, representative depth values are found, and then, disparity prediction is performed on the basis of the representative depth values found by each method. Then, a method in which the smallest prediction errors occur is adaptively selected. If a representative depth value is adaptively determined as described above, it is necessary to add a selected method to the above-described coded stream and to provide it to an image decoding apparatus. It is preferable, however, that, as in the method (c), the representative-depth-value determining unit 202 determines, as a representative value, the largest depth value within a block divided from a depth image and the disparity calculator 203 of the disparity information generator 104, which will be discussed later, utilizes the largest depth value as a representative value. With this method, a disparity can be prevented from being underestimated.

The block size used for dividing a depth image is not restricted to the above-described 16×16 size, but may be an 8×8 or 4×4 size. The number of pixels in rows and the number of pixels in columns do not have to be the same, and, for example, the block size may be a 16×8, 8×16, 8×4, or 4×8 size. The block size may be allowed to match the block size of a block to be coded used by the image coder 106, which will be discussed later. Alternatively, a suitable block size may be selected in accordance with the size of a subject contained in a depth image or in a corresponding viewpoint image or in accordance with a required compression rate.

Referring back to FIG. 2, the disparity calculator 203 calculates a disparity value of an input block, on the basis of the above-described representative depth value and information indicating an inter-camera distance and an imaging distance included in the input imaging-condition information. In this case, the depth value included in the depth image is not an actual distance from a camera to a subject, but a distance range included in a captured image represented by a predetermined numeric range (for example, 0 to 255). Accordingly, on the basis of information indicating a distance range when an image was captured included in the imaging-condition information (for example, such information indicating the largest value and the smallest value of a distance from a camera to a subject included in the image), the depth value is converted into an image distance, which is an actual distance, so that it can be on the same level as the numeric values of the imaging distance and the inter-camera distance, which represent actual distances. An equation for calculating the disparity value is defined as follows, assuming that d is a disparity value, I is an imaging distance, L is an inter-camera distance, and Z is an image distance (representative value).

d={(I−Z)/Z}×L=(I/Z−1)×L (1)

The distance information extracting unit 204 extracts information corresponding to the inter-camera distance (L) and the imaging distance (I), and sends the extracted information to the disparity calculator 203. Information concerning cameras (generally referred to as “camera parameters”) included in the imaging-condition information corresponds to internal parameters (focal length, horizontal scale factor, vertical scale factor, image center coordinates, and distortion coefficient), external parameters (rotation matrix and translation matrix), and information other than the camera parameters (the nearest value and the farthest value). Strictly speaking, the inter-camera distance (L) is not included in the camera parameters; however, it can be calculated by using the above-described translation matrix. Moreover, strictly speaking, the imaging distance (I) itself is not included in the imaging-condition information; however, it can be calculated from the difference between the above-described nearest value and farthest value. In this manner, the distance information extracting unit 204 of the disparity information generator 104 may calculate the inter-camera distance and the imaging distance from information indicating the positional relationships between a subject and cameras which were set when multiview images were captured. The nearest value and the farthest value are used for the above-described conversion processing for converting a depth image into an actual distance value.

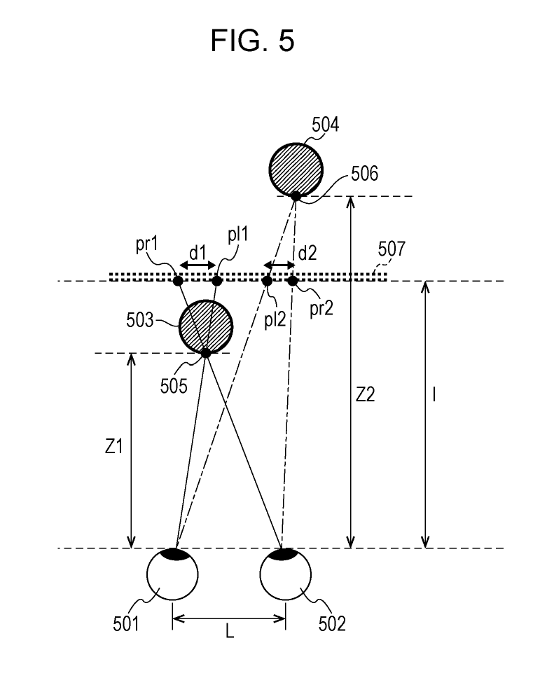

Equation (1) and the meanings of the individual parameters will be explained below. FIG. 5 is a conceptual diagram illustrating the relationship between a depth value and a disparity value. It is now assumed that the positional relationships between viewpoints, that is, cameras 501 and 502, and subjects 503 and 504 are such as that shown in FIG. 5. In this case, points 505 and 506 of the front sides of the subjects are projected at positions pl1 and pr1 and pl2 and pr2 on a plane 507 represented by the imaging distance I from the cameras. If the plane 507 is considered as a screen plane when the subjects are displayed, pl1 and pr1 are points corresponding to pixels of a left-view image and a right-view image concerning the point 505 of the subject. Similarly, pl2 and pr2 are points corresponding to pixels of a left-view image and a right-view image concerning the point 506 of the subject.

It is assumed that the distance between the two cameras is indicated by L, the imaging distance of the cameras is indicated by I, and the distances from the cameras to the points 505 and 506 at the front sides of the subjects are indicated by Z1 and Z2, respectively. Then, the relationships between disparities d1 and d2, which each indicates a difference between the left-view image and the right-view image of the corresponding subject, and the above-described parameters are established, as expressed by the following mathematical equations (2) and (3).

L:Z1=d1:(I−Z1) (2)

L:Z2=d2:(Z2−I) (3)

Then, if the disparity value d is defined as the position of a corresponding point of a left-view image associated with a corresponding point of a right-view image, the disparity value d can be obtained from the above-described mathematical equation (1). As the disparity information output from the disparity calculator 203, vectors based on both of the corresponding points are calculated and utilized. In this manner, the disparity information generator 104 generates disparity information indicating a disparity between a viewpoint image to be coded and a different viewpoint image.

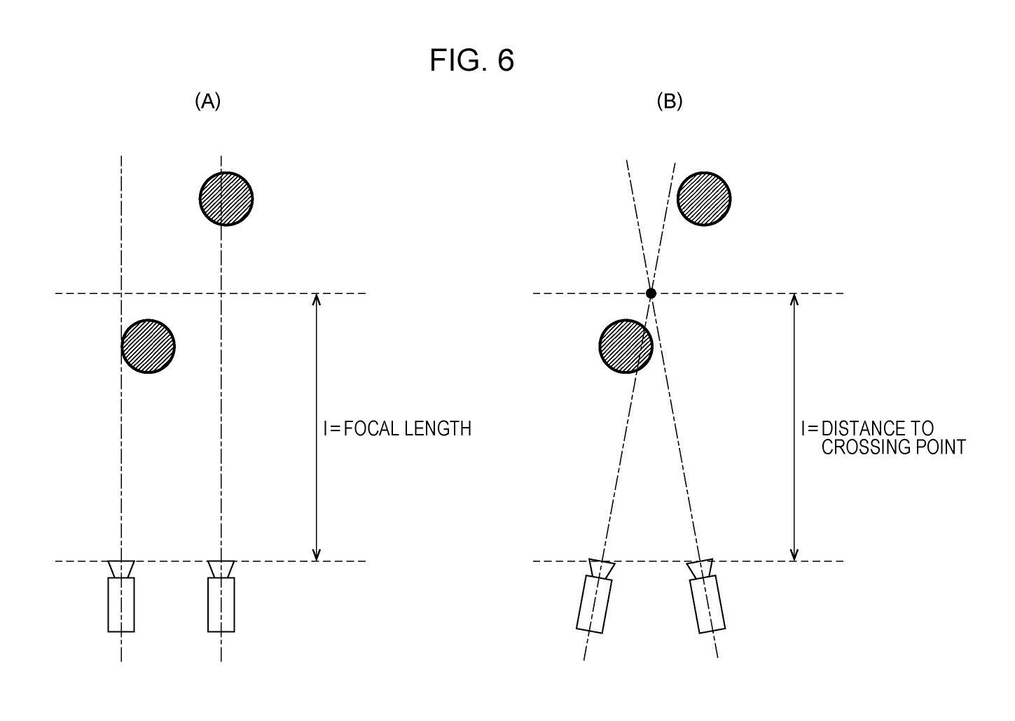

Concerning the above-described camera imaging distance I, in the case of parallel viewing imaging, that is, if the optical axes of the two cameras are in parallel, as shown in FIG. 6(A), the distance when the subjects are in focus (focal length) is considered to be I. In the case of cross viewing imaging, that is, if the optical axes of the two cameras cross each other in front, as shown in FIG. 6(B), the distance from the cameras to the crossing point is considered to be I.

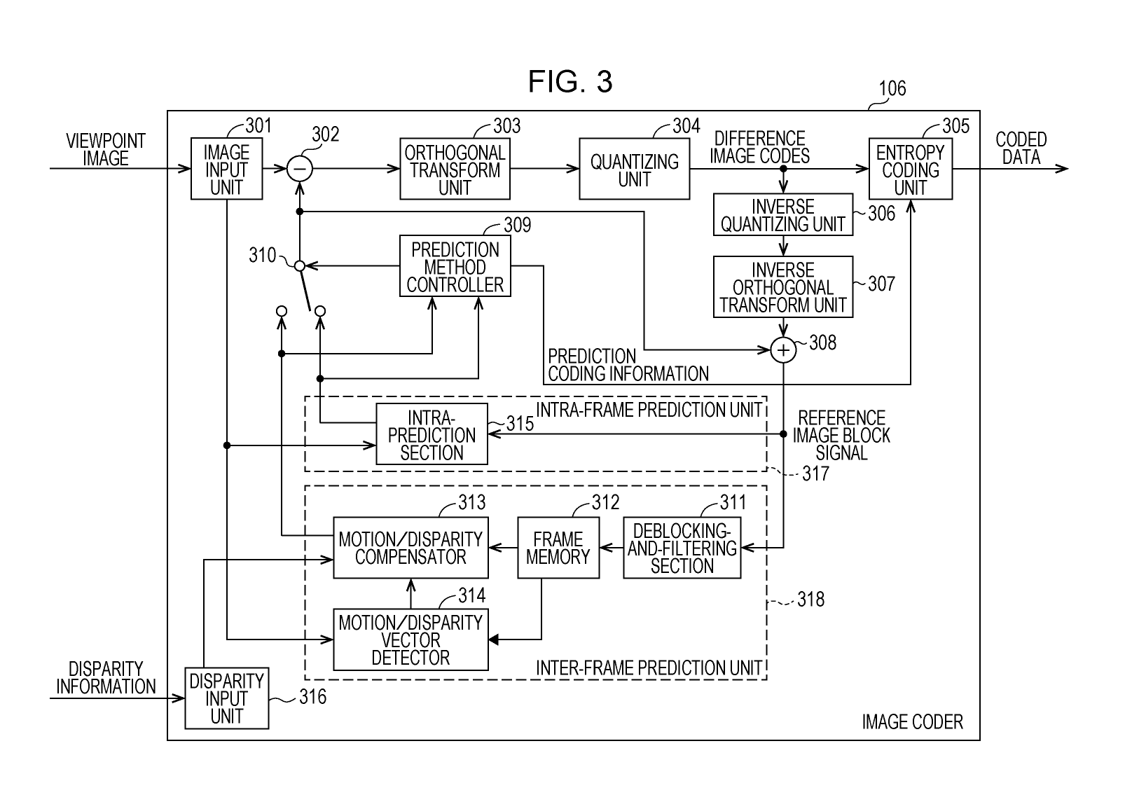

The image coder 106 will be described below with reference to FIG. 3. FIG. 3 is a schematic block diagram illustrating the functional configuration of the image coder 106.

The image coder 106 includes an image input unit 301, a subtractor 302, an orthogonal transform unit 303, a quantizing unit 304, an entropy coding unit 305, an inverse quantizing unit 306, an inverse orthogonal transform unit 307, an adder 308, a prediction method controller 309, a selector 310, a deblocking-and-filtering section 311, a frame memory (frame memory unit) 312, a motion/disparity compensator 313, a motion/disparity vector detector 314, an intra-prediction section 315, and a disparity input unit 316. For representation, an intra-frame prediction unit 317 and an inter-frame prediction unit 318 are indicated by the broken lines. The intra-frame prediction unit 317 includes the intra-prediction section 315, and the inter-frame prediction unit 318 includes the deblocking-and-filtering section 311, the frame memory 312, the motion/disparity compensator 313, and the motion/disparity vector detector 314.

When the operation of the image coder 106 has been discussed with reference to FIG. 1, coding of a base view and coding of non-base views other than the base view have been explicitly separated, and it has been assumed that base view coding is performed by the base-view coding processor 102, while non-reference-view coding is performed by the non-base-view coding processor 105. In practice, however, there are many processing operations in common to be performed both by the base-view coding processor 102 and the non-base-view coding processor 105. Accordingly, an integrated mode of base view coding processing and non-reference-view coding processing will be described below. More specifically, the above-described intra-view prediction coding method performed by the base-view coding processor 102 is a combination of processing performed by the intra-frame prediction unit 317 shown in FIG. 3 and processing for referring to an image of the same viewpoint (motion compensation), which is part of processing performed by the inter-frame prediction unit 318. The above-described inter-view prediction coding method performed by the non-base-view coding processor 105 is a combination of processing performed by the intra-frame prediction unit 317 and processing for referring to an image of the same viewpoint (motion compensation) and processing for referring to an image of a different viewpoint (disparity compensation) performed by the inter-frame prediction unit 318. Concerning the processing for referring to an image of the same viewpoint as that of an image to be processed (motion compensation) and the processing for referring to an image of a different viewpoint (disparity compensation) performed by the inter-frame prediction unit 318, the only difference is images which are referred to when performing coding, and by using ID information (reference view number and reference frame number) indicating a reference image, the two processing operations can be integrated into the same operation. Additionally, coding of a residual component between an image predicted by each of the intra-frame prediction unit 317 and the inter-frame prediction unit 318 and an input viewpoint image may also be performed uniquely regardless of whether an image to be coded is a base view image or a non-base view image. Details will be given later.

The image input unit 301 divides an image signal indicating a viewpoint image (base view image or non-base view image) to be coded input from the outside of the image coder 106 into blocks having a predetermined size (for example, 16×16 pixels in the vertical direction and in the horizontal direction).

The image input unit 301 outputs a divided image block signal to the subtractor 302, the intra-prediction section 315 included in the intra-frame prediction unit 317 and the motion/disparity vector detector 314 included in the inter-frame prediction unit 318. The intra-frame prediction unit 317 is a processor that performs coding only by using information within the same frame which has been processed prior to a block to be coded. Details of the processing will be discussed later. On the other hand, the inter-frame prediction unit 318 is a processor that performs coding by using information concerning the same viewpoint image or a different viewpoint image which has been processed and which is different from an image to be coded. Details of the processing will be discussed later. The image input unit 301 repeatedly outputs a divided image block signal by sequentially changing the block positions until all of blocks within an image frame have been processed and until all of input images have been processed.

The block size used for dividing an image signal by the image input unit 301 is not restricted to the above-described 16×16 size, but may be an 8×8 or 4×4 size. The number of pixels in rows and the number of pixels in columns do not have to be the same, and, for example, the block size may be a 16×8, 8×16, 8×4, or 4×8 size. These examples of the sizes are coding block sizes used in a known method, such as H.264 or MVC. According to a coding procedure, which will be discussed below, an image signal is coded by using all the block sizes, and then, the block size which implements the high coding efficiency is selected. The block size is not restricted to the above-described sizes.

The subtractor 302 subtracts a prediction image block signal input from the selector 310 from an image block signal input from the image input unit 301, thereby generating a difference image block signal. The subtractor 302 outputs the generated difference image block signal to the orthogonal transform unit 303.

The orthogonal transform unit 303 performs orthogonal transform on the difference image block signal input from the subtractor 302 so as to generate a signal indicating intensity levels of various frequency characteristics. When performing orthogonal transform on the difference image block signal, the orthogonal transform unit 303 performs, for example, DCT (Discrete Cosine Transform), on the difference image block signal so as to generate a frequency domain signal (for example, DCT coefficients if DCT is performed). The orthogonal transform unit 303 may utilize a technique (for example, FFT (Fast Fourier Transform)) other than DCT as long as it can generate a frequency domain signal on the basis of the difference image block signal. The orthogonal transform unit 303 outputs coefficient values included in the generated frequency domain signal to the quantizing unit 304.

The quantizing unit 304 quantizes the coefficient values indicating frequency characteristic intensity levels input from the orthogonal transform unit 303 with a predetermined quantization coefficient, and outputs the generated quantizing signal (difference image block codes) to the entropy coding unit 305 and the inverse quantizing unit 306. The quantization coefficient is a parameter for determining the amount of data for coding, which is input from the outside of the image coding apparatus 100, and is also referred to by the inverse quantizing unit 306 and the entropy coding unit 305.

The inverse quantizing unit 306 performs processing reverse to quantizing processing performed by the quantizing unit 304 (inverse quantizing processing) on the difference image codes input from the quantizing unit 304 by using the above-described quantization coefficient, thereby generating a decoded frequency domain signal. The inverse quantizing unit 306 then outputs the generated decoded frequency domain signal to the inverse orthogonal transform unit 307.

The inverse orthogonal transform unit 307 performs processing reverse to processing performed by the orthogonal transform unit 303, for example, inverse DCT, on the input decoded frequency domain signal, thereby generating a decoded difference image block signal, which is a spatial domain signal. The inverse orthogonal transform unit 307 may utilize a technique (for example, IFFT (Inverse Fast Fourier Transform)) other than inverse DCT as long as it can generate a spatial domain signal on the basis of the decoded frequency domain signal. The inverse orthogonal transform unit 307 outputs the generated decoded difference image block signal to the adder 308.

The adder 308 receives the prediction image block signal from the selector 310 and the decoded difference image block signal from the inverse orthogonal transform unit 307. The adder 308 adds the decoded difference image block signal to the prediction image block signal so as to generate a reference image block signal obtained by coding and decoding the input image (internal decoding). This reference image block signal is output to the intra-frame prediction unit 317 and the inter-frame prediction unit 318.

Upon receiving the reference image block signal from the adder 308 and the image block signal indicating an image to be coded from the image input unit 301, the intra-frame prediction unit 317 outputs an intra-frame prediction image block signal obtained by performing intra-frame prediction in a predetermined direction to the prediction method controller 309 and the selector 310. At the same time, the intra-frame prediction unit 317 outputs information indicating the direction of prediction which is necessary for generating the intra-frame prediction image block signal to the prediction method controller 309 as intra-frame prediction coding information. The intra-frame prediction is performed in accordance with a known intra-frame prediction method (for example, H.264 Reference Software JM ver. 13.2 Encoder, http://iphome.hhi.de/suchring/tml/, 2008).

Upon receiving the reference image block signal from the adder 308, the image block signal indicating an image to be coded from the image input unit 301, and disparity information from the disparity input unit 316, the inter-frame prediction unit 318 outputs an inter-frame prediction image block signal obtained by performing inter-frame prediction to the prediction method controller 309 and the selector 310. At the same time, the inter-frame prediction unit 318 outputs the generated inter-frame prediction coding information to the prediction method controller 309. Details of the inter-frame prediction unit 318 will be discussed later.

The disparity input unit 316 receives, from the disparity information generator 104, disparity information corresponding to the above-described viewpoint image input into the image input unit 301. The block size of the input disparity information is the same as the block size of the image signal. The disparity input unit 316 outputs the input disparity information to the motion/disparity compensator 313 as a disparity vector signal.

Then, on the basis of the type of picture of the input image (information for identifying an image which can be referred to by an image to be coded as a prediction image, and the types of pictures include an I picture, a B picture, or a P picture. The type of picture is determined by a parameter provided from the outside of the image coding apparatus 100, as in the quantization coefficient, and may be determined by utilizing the same method as a known method, such as MVC) and the coding efficiency, the prediction method controller 309 determines a prediction method from the intra-frame prediction image block signal and the intra-frame prediction coding information input from the intra-frame prediction unit 317 and the inter-frame prediction image block signal and the inter-frame coding information input from the inter-frame prediction unit 318, and outputs information indicating the determined prediction method to the selector 310. The prediction method controller 309 monitors the type of picture of the input image. If the input image to be coded is an I picture which can refer to only intra-frame information, the prediction method controller 309 definitely selects the intra-frame prediction method. If the input image to be coded is a P picture which can refer to a preceding coded frame or a different viewpoint image, or a B picture which can refer to preceding and following coded frames (although such a following coded frame is a future frame in the display order, it has already been coded) or a different viewpoint image, the prediction method controller 309 calculates the Lagrange cost by using a known method (for example, H.264 Reference Software JM ver. 13.2 Encoder, http://iphome.hhi.de/suchring/tml/, 2008) from the number of bits generated by coding performed by the entropy coding unit 305 and from the difference from the original image calculated by the subtractor 302, thereby selecting the intra-frame prediction method or the inter-frame prediction method.

At the same time, the prediction method controller 309 adds information for specifying the prediction method selected by the above-described method to one of the intra-frame prediction coding information and the inter-frame prediction coding information corresponding to the selected prediction method, and outputs the resulting coding information to the entropy coding unit 305 as prediction coding information.

In accordance with information indicating the prediction method input from the prediction method controller 309, the selector 310 selects the intra-frame prediction image block signal input from the intra-frame prediction unit 317 or the inter-frame prediction image block signal input from the inter-frame prediction unit 318, and outputs the selected prediction image block signal to the subtractor 302 and the adder 308. If the information indicating the prediction method input from the prediction method controller 309 indicates intra-frame prediction, the selector 310 selects and outputs the intra-frame prediction image block signal input from the intra-frame prediction unit 317. If the information indicating the prediction method input from the prediction method controller 309 indicates inter-frame prediction, the selector 310 selects and outputs the inter-frame prediction image block signal input from the inter-frame prediction unit 318.

The entropy coding unit 305 performs packing of the difference image codes and the quantization coefficient input from the quantizing unit 304 and the prediction coding information input from the prediction method controller 309, and codes such items of information by using, for example, variable-length coding (entropy coding). As a result, coded data of a highly compressed amount of information is generated. The entropy coding unit 305 outputs the generated coded data to the outside (for example, the image decoding apparatus 700) of the image coding apparatus 100.

The inter-frame prediction unit 318 will be discussed in detail below.

Upon receiving the reference image block signal from the adder 308, the deblocking-and-filtering section 311 performs FIR filtering processing which is used in a known method (for example, H.264 Reference Software JM ver. 13.2 Encoder, http://iphome.hhi.de/suchring/tml/, 2008) in order to reduce block distortion produced during the coding of an image. The deblocking-and-filtering section 311 outputs the processing results (corrected block signal) to the frame memory 312.

Upon receiving the corrected block signal from the deblocking-and-filtering section 311, the frame memory 312 retains the corrected block signal as part of an image, together with information for identifying a viewpoint number and a frame number. In the frame memory 312, a memory manager (not shown) manages the types of pictures or the image order, and the frame memory 312 stores or discards images in response to an instruction of the memory manager. The management of images may also be performed by utilizing an image management technique in MVC, which is a known method.

The motion/disparity vector detector 314 searches images stored in the frame memory 312 for a block which resembles an image block signal input from the image input unit 301 (block matching), and generates vector information indicating the searched block, the viewpoint number, and the frame number (in this case, vector information indicates a motion vector if a reference image has the same viewpoint as that of an image to be coded, and vector information indicates a disparity vector if a reference image has a viewpoint different from that of an image to be coded). When performing block matching, the motion/disparity vector detector 314 calculates an index value indicating the difference between each region of images stored in the frame memory 312 and the divided block of the input image, and searches for a region having the smallest index value. As the index value, any type of value indicating the correlation or the similarity between image signals may be used. The motion/disparity vector detector 314 utilizes, for example, the sum of absolute differences (SAD) between the luminance values of pixels included in a divided block and the luminance values of the corresponding pixels in a certain region of a reference image. SAD indicating the difference between a block (for example, a size of NXN pixels) divided from the input viewpoint image signal and a block of the reference image signal is represented by the following equation.

$$\begin{matrix}[ Math . 1 ] & \\ SAD ( p , q ) = {\sum }_{i = 0}^{N - 1} {\sum }_{j = 0}^{N - 1} \vert \begin{matrix}{I}_{i n} ( {i}_{0} + i , {j}_{0} + j ) - \\ {I}_{ref} ( {i}_{0} + i + p , {j}_{0} + j + q )\end{matrix} \vert & ( 4 )\end{matrix}$$

In mathematical equation (4), Iᵢₙ(i₀+i, j₀+j) denotes the luminance value of the coordinates (i₀+i, j₀+j) of an input image, and (i₀, j₀) denotes the coordinates of a pixel at the top left corner of the divided block. I_{ref}(i₀+i+p, j₀+j+q) denotes the luminance value of the coordinates (i₀+i+p, j₀+j+q) of a reference image, and (p, q) denotes the amount by which the coordinates (i₀+i+p, j₀+j+q) are shifted (motion vector) from the coordinates of the top left corner of the divided block.

That is, in block matching, the motion/disparity vector detector 314 calculates SAD(p, q) for each (p, q), and searches for (p, q) which minimizes SAD(p, q). (p, q) represents a vector (motion/disparity vector) from the block divided from the input viewpoint image to the position of the reference region.

The motion/disparity compensator 313 receives a motion vector or a disparity vector from the motion/disparity vector detector 314 and disparity information from the disparity input unit 316. On the basis of the input motion/disparity vector, the motion/disparity compensator 313 extracts the image block of the corresponding region from the frame memory 312, and outputs the extracted image block to the prediction method controller 309 and the selector 310 as an inter-frame prediction image block signal. The motion/disparity compensator 313 also subtracts a prediction vector, which has been generated on the basis of the above-described disparity information and a motion/disparity vector used in a coded block adjacent to the block to be coded, from the motion/disparity vector calculated in the above-described block matching, thereby calculating a difference vector. A generation method for a prediction vector will be discussed later. The motion/disparity compensator 313 interconnects and rearranges the above-described difference vector and reference image information (reference viewpoint image number and reference frame number), and outputs the interconnected information to the prediction method controller 309 as inter-frame coding information. It is necessary that at least the reference viewpoint image number and the reference frame number of a region which is found to be most similar to the input image block in the block matching coincide with those of a region pointed by the prediction vector.

A description will now be given of a generation method for a prediction vector according to the present invention. Concerning a prediction vector of the present invention, in a manner similar to the known method shown in FIG. 16, a median value of horizontal components and that of vertical components of motion vectors (mv_a, mv_b, and mv_c) of a block (adjacent block A in FIG. 16) positioned immediately on the top side of a block to be coded, a block (adjacent block B in FIG. 16) positioned on the top right side of the block to be coded, and a block (adjacent block C in FIG. 16) positioned on the left side of the block to be coded are set to be a prediction vector. However, if the coding method of an adjacent block is different from the disparity-compensated prediction method utilized for the block to be coded, a disparity vector, which is disparity information input from the disparity input unit 316 shown in FIG. 3, is utilized for such an adjacent block.

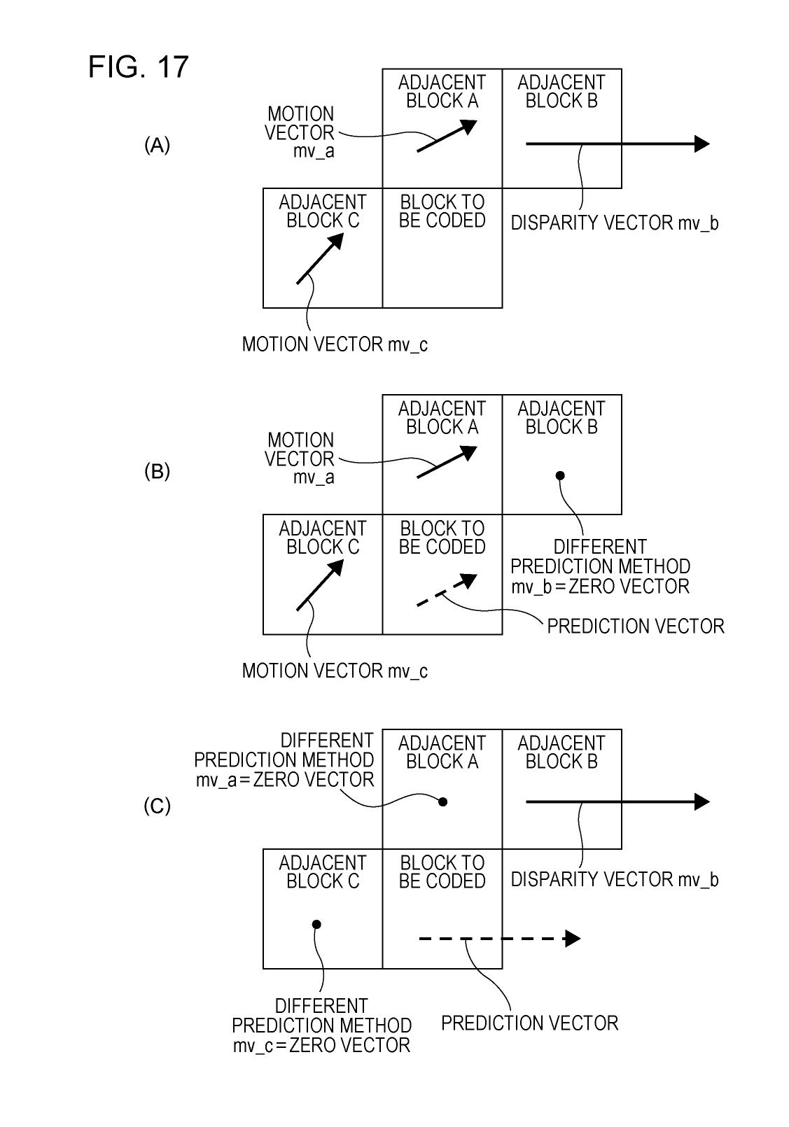

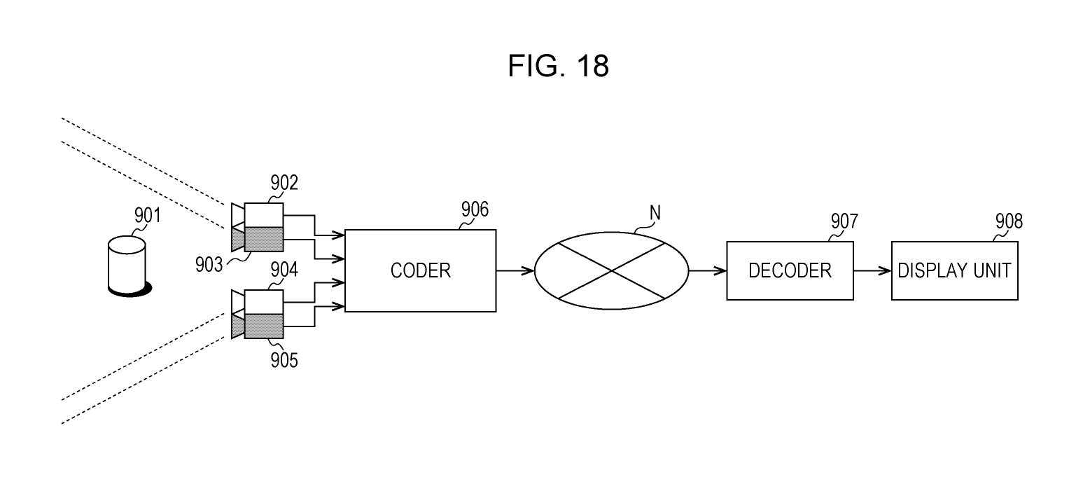

In the example shown in FIG. 16, the motion-compensated method, which is different from the disparity-compensated prediction method, is utilized for the adjacent blocks A, B, and C. Thus, disparity information concerning the corresponding blocks, that is, disparity vectors, are input from the disparity input unit 316, and all of the motion vectors of the adjacent blocks A, B, and C are replaced by the disparity vectors. Then, a prediction vector for a block to be coded with respect to a base view image is generated. In another example, in FIG. 17, motion vectors of the adjacent blocks A and C are replaced by disparity vectors, which are disparity information input from the disparity input unit 316. Then, a prediction vector for a block to be coded with respect to a base view image is generated.

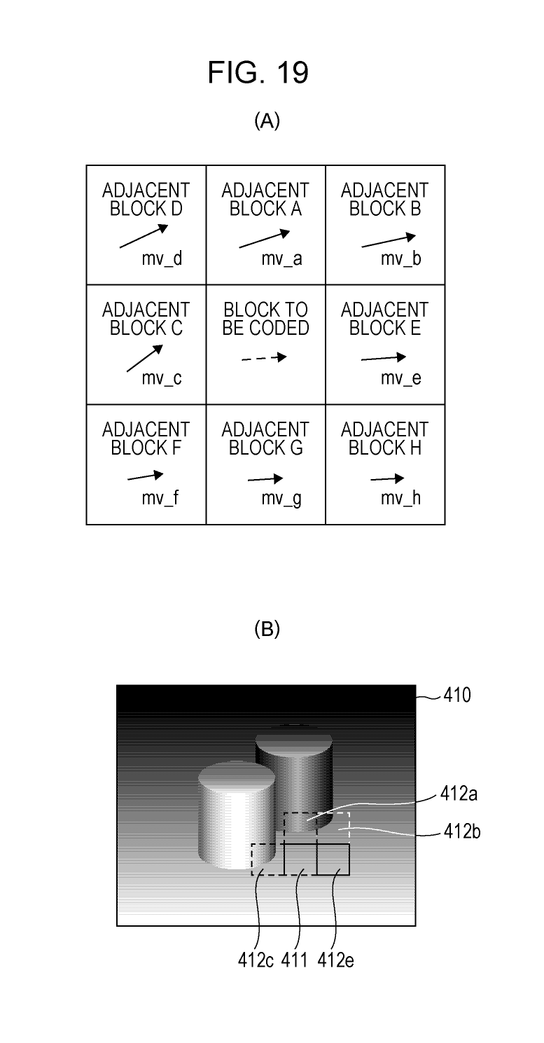

Adjacent blocks utilized for generating a prediction vector are not restricted to the positions of the blocks A, B, and C shown in FIG. 16, and other adjacent blocks may be utilized. An example of the generation method for a prediction vector by utilizing other adjacent blocks will be discussed below with reference to FIG. 19.

As an example of the generation method for a prediction vector by utilizing other adjacent blocks, for example, as shown in FIG. 19(A), not only vectors mv_a through mv_c corresponding to adjacent blocks A, B, and C, respectively, but also vectors mv_d through mv_h corresponding to adjacent blocks D, E, F, G, and H, respectively, may be added to candidates for generating a prediction vector. For example, if a depth image 410 shown in FIG. 19(B) is a depth image corresponding to a viewpoint image to be coded and a block 411 is located at a position of a block to be coded of the viewpoint image, among regions around the block 411, the region having the most similar disparity with respect to the block 411 is not blocks 412a, 412b, and 412c corresponding to the adjacent blocks A, B, and C, but a block 412e corresponding to an adjacent block E. In such a case, a disparity vector of the adjacent block 412e is utilized rather than disparity vectors of the adjacent blocks 412a through 412c, thereby making it possible to enhance the precision (accuracy) in generating a prediction vector concerning a block to be coded. Alternatively, in addition to the disparity vectors of the adjacent blocks 412a through 412c, the disparity vector of the adjacent block 412e may also be included as a candidate for generating a prediction vector, thereby making it possible to enhance the precision in generating a prediction vector. Moreover, if, for example, a foreground subject is included in the block to be coded and in the adjacent blocks E, F, G, and H, and the adjacent blocks A, B, C, and D are occupied by a background, disparities of the adjacent blocks E, F, G, and H with respect to the block to be coded are more similar than disparities of the adjacent blocks A, B, C, and D. Accordingly, by including the adjacent blocks E, F, G, and H as well as the adjacent blocks A, B, C, and D as candidates for generating a prediction vector, the precision in generating a prediction vector can be enhanced.

A method for generating a prediction vector by utilizing the adjacent blocks A through H is as follows. If the address of a block to be coded is set to be (x₀, y₀), the disparity information generator 104 determines representative depth values and calculates disparities of blocks of an associated depth image until the block address (x₀+1, y₀+1), that is, until the block H in FIG. 19(A). Then, upon receiving, from the disparity input unit 316, disparity information corresponding to the adjacent blocks A through H of the block to be coded, the motion/disparity compensator 313 calculates a median value of horizontal components and that of vertical components from disparity information (disparity vectors) of the adjacent blocks A through H, and sets the calculated median values to be a prediction vector of the block to be coded.

As another method for generating a prediction vector, instead of utilizing all of the adjacent eight blocks A through H, some of the adjacent blocks A through H may be utilized for generating a prediction vector. For example, as discussed above, an approach to determining the range of blocks to be utilized to be the adjacent blocks A through C may be referred to as a basic “mode 0”. In contrast to this basic mode, “mode 1”, “mode 2”, “mode 3”, “mode 4”, and “mode 5” in which the adjacent blocks D, E, F, G, and H, as those shown in FIG. 19(A), are sequentially added to a range of adjacent blocks may be defined, and one of mode 1 through mode 5 may be selected. Alternatively, instead of setting the above-described modes, one or a plurality of the adjacent eight blocks may be determined as adjacent blocks to be utilized. If such an approach may be adopted, the representative depth values of individual blocks determined by the disparity information generator 104 may be stored. Then, by referring to such representative depth values, the motion/disparity compensator 313 may determine the adjacent block having a representative depth value closest to that of the block to be coded or a predetermined number (for example, three) of adjacent blocks having representative depth values first, second, and third closest to that of the block to be coded as adjacent blocks to be utilized for generating a prediction vector.

If the range of blocks to be utilized for generating a prediction vector (that is, for predicting a disparity vector) is determined as the image coding/decoding standards, the image coding apparatus 100 may determine adjacent blocks in advance. Alternatively, the image coding apparatus 100 may determine adjacent blocks in accordance with an application or conditions, such as the resolution of an input image or the frame rate. In this case, the determination results are transmitted, together with coded image data, as prediction range instruction information indicating the range of adjacent blocks utilized for predicting a disparity vector. The prediction range instruction information may be transmitted as part of prediction coding information. The prediction range instruction information may be constituted by “mode 0”, “mode 1”, “mode 2”, and so on, indicating the range of adjacent blocks selected from the adjacent eight blocks. Alternatively, the prediction range instruction information may directly indicate which of the adjacent eight blocks is to be utilized. In this case, the prediction range instruction information may indicate one or a plurality of adjacent blocks.

As described above, concerning a viewpoint image to be coded, the motion/disparity compensator 313 generates a prediction vector for a different viewpoint image (that is, a viewpoint image different from the viewpoint image to be coded) on the basis of disparity information. The prediction vector generated by the motion/disparity compensator 313 is a prediction vector to be utilized for coding an image to be coded (block to be coded), and a destination (block) pointed by this prediction vector is a block contained in the different viewpoint image (block which has been specified in block matching).

In this method, disparity information is generated by using a depth image corresponding to an image to be coded. Accordingly, disparity information can be obtained for all image blocks. Additionally, since disparity information is generated from a depth image at the same time point as that of an image to be coded, the occurrence of the above-described temporal errors of a disparity vector caused by the motion of a subject can be avoided. Accordingly, if the reliability of an input depth image is sufficiently high, it is possible to enhance the precision of prediction vectors by utilizing this method. Moreover, in this method, disparity vectors of adjacent blocks which are not possible to utilize for prediction are replaced. Thus, after the replacement of vectors, processing can be performed within the same framework as that of a known method. Additionally, since a median value in the horizontal direction and that in the vertical direction of disparity vectors of adjacent blocks can be utilized, it is possible to eliminate factors of unexpected errors of disparity vectors (among the disparity vectors of the adjacent blocks A, B, and C, an abnormal vector in a certain adjacent block produced independently of the other adjacent blocks).

Instead of utilizing the above-described method, a prediction vector may be generated in the following manner. For example, the following alternative method (a) may be employed. In the above-described method, for a block in which a vector is required to be replaced, corresponding disparity information is input from the disparity input unit 316, and then, the block is corrected. However, it is not always necessary to replace such a vector by corresponding disparity information. For example, a disparity vector, which is disparity information calculated from depth information concerning a block to be coded, may be utilized. Or, the following alternative method (b) may be employed. Instead of utilizing the above-described replacement method, a disparity vector, which is disparity information calculated from depth information of a block to be processed, may always be set to be a prediction vector. In the alternative method (a), disparity information concerning a block to be coded, which is positioned closer than surrounding blocks, can be advantageously utilized. In the alternative method (b), since a prediction vector is directly generated from disparity information input from the disparity input unit 316, it is not possible to prevent the occurrence of the above-described factors of unexpected errors. However, it is not necessary to calculate median values from disparity vectors of surrounding blocks, thereby advantageously making it possible to reduce the amount of calculations.

The generation method for a prediction vector may be fixed for coding and decoding in advance. Alternatively, a suitable method may be selected for each block. If a suitable method is selected for each block, it is necessary for the entropy coding unit 305 to interconnect the method selected for coding processing with other items of coding information and to code the interconnected information. Then, when decoding such information, it is necessary to refer to the selected method and to switch the generation method for a prediction vector.

In the generation method for a prediction vector, as discussed above, it is sufficient that, among surrounding blocks adjacent to a block to be coded which will be utilized for generating a prediction vector, information based on disparity information is applied only to blocks from which it is not possible to obtain information required for generating a prediction vector (blocks which utilize a different prediction method or blocks from which it is not possible to obtain information for another reason). However, it is possible to apply information based on disparity information also to blocks from which required information can be obtained. That is, in the method for generating a prediction vector, regardless of whether or not an adjacent block is a block from which required information can be obtained, information based on disparity information concerning a block to be coded may be utilized.

### <Flowchart of Image Coding Apparatus 100>

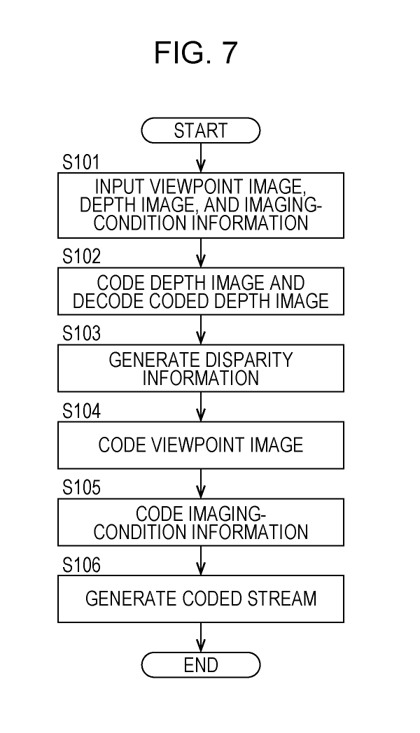

A description will be given below of image coding processing performed by the image coding apparatus 100 according to this embodiment. FIG. 7 is a flowchart illustrating image coding processing performed by the image coding apparatus 100. The image coding processing will be discussed with reference to FIG. 1.

In step S101, the image coding apparatus 100 receives a viewpoint image, a corresponding depth image, and corresponding imaging-condition information from the outside of the image coding apparatus 100. Then, the process proceeds to step S102.

In step S102, the depth image coder 103 codes the depth image input from the outside of the image coding apparatus 100. The depth image coder 103 outputs data indicating the coded depth image to a code constructing unit (not shown). At the same time, the depth image coder 103 decodes the data indicating the coded depth image and outputs decoding results to the disparity information generator 104. The process then proceeds to step S103.

In step S103, the disparity information generator 104 generates disparity information on the basis of the imaging-condition information input from the outside of the image coding apparatus 100 and information indicating the coded and decoded depth image input from the depth image coder 103. The disparity information generator 104 outputs the generated disparity information to the image coder 106. The process then proceeds to step S104.

In step S104, the image coder 106 codes an image on the basis of the viewpoint image input from the outside of the image coding apparatus 100 and the disparity information input from the disparity information generator 104. At the same time, the image coder 106 also codes the above-described prediction coding information and quantization coefficient. The image coder 106 outputs data indicating the coded image to the code constructing unit (not shown). The process then proceeds to step S105.

In step S105, the imaging-condition information coder 101 receives imaging-condition information from the outside of the image coding apparatus 100 and codes the imaging-condition information. The imaging-condition information coder 101 outputs data indicating the coded imaging-condition information to the code constructing unit (not shown). The process then proceeds to step S106.

In step S106, upon receiving the data indicating the coded image from the image coder 106, the data indicating the coded depth image from the depth image coder 103, and the data indicating the coded imaging-condition information from the imaging-condition information coder 101, the code constructing unit (not shown) interconnects and rearranges the items of coded data, and outputs the interconnected data to the outside of the image coding apparatus 100 as a coded stream.

The generation of disparity information performed in step S103 and the coding of a viewpoint image performed in step S104 will be described in greater detail.

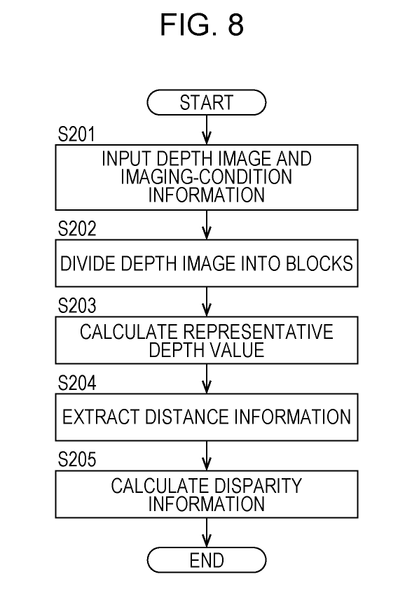

The generation of disparity information in step S103 will first be discussed with reference to FIGS. 8 and 2.

In step S201, the disparity information generator 104 receives a depth image and imaging-condition information from the outside of the image coding apparatus 100. The disparity information generator 104 outputs the depth image and the imaging-condition information to the block divider 201 and the distance information extracting unit 204, respectively, which are disposed within the disparity information generator 104. The process then proceeds to step S202.

In step S202, the block divider 201 receives the depth image and divides it into blocks having a predetermined block size. The block divider 201 outputs the divided depth image blocks to the representative-depth-value determining unit 202. The process then proceeds to step S203.

In step S203, upon receiving the depth image divided by the block divider 201, the representative-depth-value determining unit 202 determines a representative depth value in accordance with the above-described method for calculating a representative depth value. The representative-depth-value determining unit 202 outputs the calculated representative depth value to the disparity calculator 203. The process then proceeds to step S204.

In step S204, upon receiving the imaging-condition information, the distance information extracting unit 204 extracts information indicating the inter-camera distance and the imaging distance from the imaging-condition information, and outputs the extracted information to the disparity calculator 203. The process then proceeds to step S205.

In step S205, upon receiving the representative depth value from the representative-depth-value determining unit 202 and the imaging-condition information required for calculating disparity information from the distance information extracting unit 204, the disparity calculator 203 calculates disparity information, that is, a disparity vector, in accordance with the above-described disparity calculating method. The disparity calculator 203 outputs the calculated disparity information, that is, the disparity vector, to the outside of the disparity information generator 104.

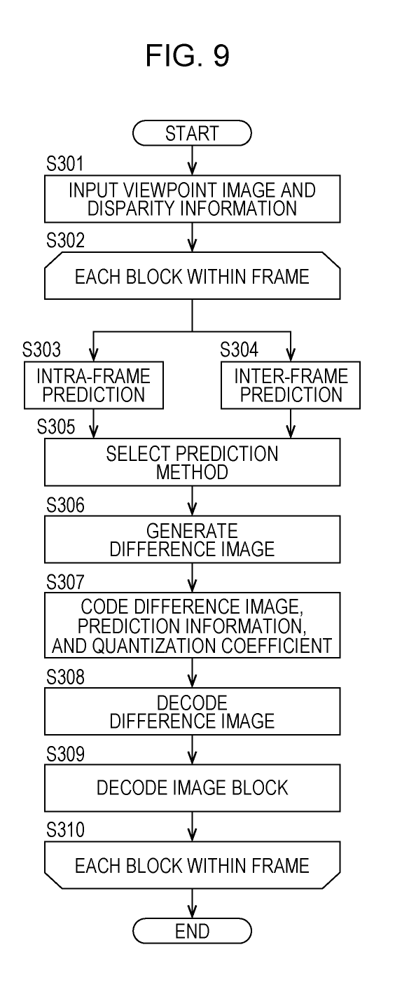

Then, the coding of a viewpoint image performed in step S104 will be discussed below with reference to FIGS. 9 and 3.

In step S301, the image coder 106 receives a viewpoint image and corresponding disparity information from the outside of the image coder 106. The process then proceeds to step S302.

In step S302, the image input unit 301 divides an input image signal, which is the viewpoint image input from the outside of the image coder 106, into blocks having a predetermined size (for example, 16×16 pixels in the vertical direction and in the horizontal direction), and outputs a divided block to the subtractor 302, the intra-frame prediction unit 317 and the inter-frame prediction unit 318. The disparity input unit 316 divides disparity information, that is, a disparity vector, which synchronizes with the viewpoint image input into the image input unit 301, in a manner similar to the division of the image performed by the image input unit 301, and outputs the divided disparity information to the inter-frame prediction unit 318.

The image coder 106 repeats steps S302 through S310 for each of the image blocks within a frame. The process then proceeds to steps S303 and S304.

In step S303, the intra-frame prediction unit 317 receives an image block signal of the viewpoint image from the image input unit 301 and a decoded (internally decoded) reference image block signal from the adder 308, and performs intra-frame prediction. The intra-frame prediction unit 317 outputs a generated intra-frame prediction image block signal to the prediction method controller 309 and the selector 310, and outputs intra-frame prediction coding information to the prediction method controller 309. When processing in step S303 is performed for the first time, if the adder 308 has not finished processing, a reset image block (image block having all pixel values of 0) is input. Upon completing the processing of the intra-frame prediction unit, the process proceeds to step S305.

In step S304, the inter-frame prediction unit 318 receives an image block signal of the viewpoint image from the image input unit 301, a decoded (internally decoded) reference image block signal from the adder 308, and disparity information from the disparity input unit 316, and performs inter-frame prediction. The inter-frame prediction unit 318 outputs a generated inter-frame prediction image block signal to the prediction method controller 309 and the selector 310, and outputs inter-frame prediction coding information to the prediction method controller 309. When processing in step S304 is performed for the first time, if the adder 308 has not finished processing, a reset image block (image block signal having all pixel values of 0) is input. Upon completing the processing of the inter-frame prediction unit 318, the process proceeds to step S305.

In step S305, upon receiving the intra-frame prediction image block signal and the intra-frame prediction coding information from the intra-frame prediction unit 317 and the inter-frame prediction image block signal and the inter-frame prediction coding information from the inter-frame prediction unit 318, the prediction method controller 309 selects a prediction mode with higher coding efficiency on the basis of the above-described the Lagrange cost. The prediction method controller 309 outputs information indicating the selected prediction mode to the selector 310. The prediction method controller 309 adds information for identifying the selected prediction mode to the prediction coding information corresponding to the selected prediction mode, and outputs the information to the entropy coding unit 305.

The selector 310 selects the intra-frame prediction image block signal input from the intra-frame prediction unit or the inter-frame prediction image block signal input from the inter-frame prediction unit in accordance with the prediction mode information input form the prediction method controller 309, and outputs the selected prediction image block signal to the subtractor 302 and the adder 308. The process then proceeds to step S306.

In step S306, the subtractor 302 subtracts the prediction image block signal input from the selector 310 from the image block signal input from the image input unit 301 so as to generate a difference image block signal. The subtractor 302 outputs the difference image block signal to the orthogonal transform unit 303. The process then proceeds to step S307.

In step S307, the orthogonal transform unit 303 receives the difference image block signal from the subtractor 302 and performs the above-described orthogonal transform. The orthogonal transform unit 303 outputs a signal subjected to orthogonal transform to the quantizing unit 304. The quantizing unit 304 performs the above-described quantizing processing on the signal input from the orthogonal transform unit 303 so as to generate difference image codes. The quantizing unit 304 outputs the difference image codes and the quantization coefficient to the entropy coding unit 305 and the inverse quantizing unit 306.

The entropy coding unit 305 performs packing of the difference image codes and the quantization coefficient input from the quantizing unit 304 and the prediction coding information input from the prediction method controller 309, and performs variable-length coding (entropy coding). As a result, coded data of a highly compressed amount of information is generated. The entropy coding unit 305 outputs the generated coded data to the outside (for example, the image decoding apparatus 700 shown in FIG. 11) of the image coding apparatus 100. The process then proceeds to step S308.

In step S308, the inverse quantizing unit 306 receives the difference image codes from the quantizing unit 304 and performs processing reverse to quantizing processing performed by the quantizing unit 304. The inverse quantizing unit 306 then outputs the generated signal to the inverse orthogonal transform unit 307. Upon receiving the inverse quantized signal from the inverse quantizing unit 306, the inverse orthogonal transform unit 307 performs processing reverse to processing performed by the orthogonal transform unit 303, thereby decoding a difference image (decoded difference image block signal). The inverse orthogonal transform unit 307 outputs the decoded difference image block signal to the adder 308. The process then proceeds to step S309.

In step S309, the adder 308 adds the prediction image block signal input from the selector 310 to the decoded difference image block signal input from the inverse orthogonal transform unit 307 so as to decode the input image (reference image block signal). The adder 308 outputs the reference image block signal to the intra-frame prediction unit 317 and the inter-frame prediction unit 318. The process then proceeds to step S310.

In step S310, if the image coder 106 has not finished performing processing of steps S302 through S310 on all the blocks and all the viewpoint images within the frame, the block to be processed is changed, and the process returns to step S302.

If the image coder 106 has finished processing of all the blocks and all the viewpoint images, the process has been terminated.

The processing flow of intra-frame prediction performed in step S303 may be the same as processing steps of intra-frame prediction of H.264 or MVC, which is a known method.

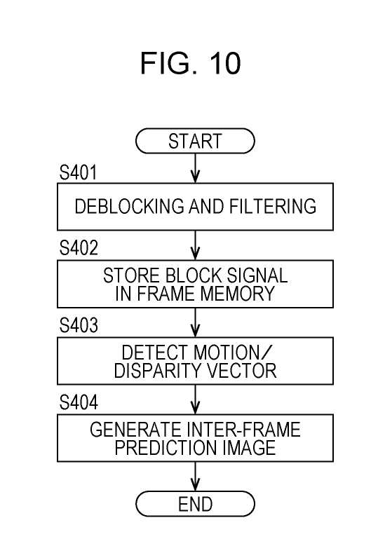

The processing flow of inter-frame prediction performed in step S304 will be described below with reference to FIGS. 10 and 3.

In step S401, upon receiving the reference image block signal from the adder 308, which is disposed outside of the inter-frame prediction unit 318, the deblocking-and-filtering section 311 performs the above-described FIR filtering processing. The deblocking-and-filtering section 311 outputs a corrected block signal subjected to filtering processing to the frame memory 312. The process then proceeds to step S402.

In step S402, upon receiving the corrected block signal from the deblocking-and-filtering section 311, the frame memory 312 retains the corrected block signal as part of an image, together with information for identifying a viewpoint number and a frame number. The process then proceeds to step S403.

In step S403, upon receiving the image block signal from the image input unit 301, the motion/disparity vector detector 314 searches reference images stored in the frame memory 312 for a block which resembles the image block (block matching), and generates vector information (motion vector/disparity vector) indicating the searched block. The motion/disparity vector detector 314 outputs information (reference viewpoint image number and reference frame number) required for performing coding by including the detected vector information to the motion/disparity compensator 313. The process then proceeds to step S404.

In step S404, the motion/disparity compensator 313 receives information required for coding from the motion/disparity vector detector 314, and extracts a corresponding prediction block from the frame memory 312. The motion/disparity compensator 313 outputs a prediction image block signal extracted from the frame memory 312 to the prediction method controller 309 and the selector 310 as an inter-frame prediction image block signal. At the same time, the motion/disparity compensator 313 also calculates a difference vector between a motion/disparity vector input from the motion/disparity vector detector 314 and a prediction vector, which has been generated on the basis of vector information concerning a vector of a block adjacent to a block to be coded and a disparity vector, which is the disparity information input from the disparity input unit 316. The motion/disparity compensator 313 then outputs the calculated difference vector and information required for prediction (reference viewpoint image number and reference frame number) to the prediction method controller 309. The inter-frame prediction processing is then terminated.

In this manner, according to this embodiment, the image coding apparatus 100 is capable of performing disparity-compensated prediction by generating a prediction vector by using a depth image corresponding to an image to be coded. More specifically, the image coding apparatus 100 is capable of performing disparity-compensated prediction by utilizing a prediction vector based on disparity information (that is, a disparity vector) calculated from this depth image. Thus, according to this embodiment, even if a prediction method different from disparity-compensated prediction is utilized for surrounding blocks of a block to be coded, the precision of prediction vectors can be enhanced, thereby making it possible to improve the coding efficiency.

### Second Embodiment

### Decoding Apparatus

FIG. 11 is a functional block diagram illustrating an example of the configuration of an image decoding apparatus, which is an embodiment of the present invention.

The image decoding apparatus 700 includes an imaging-condition information decoder 701, a depth image decoder 703, a disparity information generator 704, and an image decoder 706. Blocks shown within the image decoder 706 are utilized for explaining the operation of the image decoder 706 in a conceptual sense.

The function and the operation of the image decoding apparatus 700 will be described below.

Input data of the image decoding apparatus 700 is provided as base view image codes, non-base view image codes, depth image codes, and imaging-condition information codes separated and extracted by a code separator (not shown) from a coded stream transmitted from the outside (for example, the above-described image coding apparatus 100) of the image decoding apparatus 700.

A base-view decoding processor 702 decodes coded data which is subjected to compression coding performed by using an intra-view prediction coding method, thereby reconstructing a base view image. The reconstructed viewpoint image is directly used for display and is also used for decoding a non-base view image, which will be discussed later.

The depth image decoder 703 decodes coded data which is subjected to compression coding performed by a known method, for example, the H.264 or MVC method, thereby reconstructing a depth image. The reconstructed depth image is used for generating and displaying an image of a viewpoint different from that of the above-described reconstructed viewpoint image. In the following description, an example in which the depth image decoder 702 is included in the image decoding apparatus 700 will be discussed. However, it may be possible that the image coding apparatus 100 send raw data of a depth image, in which case, it is not necessary to provide the depth image decoder 703 in the image decoding apparatus 700 as long as the image decoding apparatus 700 is capable of receiving the raw data.

The imaging-condition information decoder 701 is an example of an information decoder for decoding information indicating positional relationships between a subject and cameras which were set when multiview images were captured. As has been discussed for the imaging-condition information coder 101, this information is only part of imaging-condition information. The imaging-condition information decoder 701 reconstructs information indicating the inter-camera distance and the imaging distance when multiview images were captured, for example, from data indicating the coded imaging-condition information. The reconstructed imaging-condition information is used, together with the depth image, for generating and displaying a required viewpoint image. The disparity information generator 704 generates disparity information (for example, disparity information indicating a disparity between a viewpoint image to be decoded and a different viewpoint image) on the basis of the reconstructed depth image and the reconstructed imaging-condition information. The method and process for generating disparity information is similar to the processing performed by the disparity information generator 104 of the above-described image coding apparatus 100.

A non-base-view decoding processor 705 decodes coded data which is subjected to compression coding by using an inter-view prediction coding method, on the basis of the reconstructed base view image and the above-described disparity information, thereby reconstructing a non-base view image. The base view image and the non-base view image are directly used as display images, and, if necessary, other viewpoint images, for example, inter-viewpoint images, are generated for display, on the basis of the depth image and the imaging-condition information. Processing for generating viewpoint images may be performed within this image decoding apparatus or outside the image decoding apparatus.

In this example, in the image coding apparatus 100, a base view image has been coded by the intra-view prediction coding method, and a non-base view image has been coded by the inter-view prediction coding method. Accordingly, in the image decoding apparatus 700, too, the base view image and the non-base view image are decoded in accordance with the associated methods. However, if both of the base view image and the non-base view image are coded by the inter-view prediction coding method in the image coding apparatus 100, they may be decoded by the inter-view prediction decoding method in the image decoding apparatus 700. If, in the image coding apparatus 100, the prediction coding method is switched on the basis of the coding efficiency, the image decoding apparatus 700 receives information indicating the prediction coding method (prediction coding information) from the image coding apparatus 100 and switches the prediction decoding method accordingly. In this case, the switching of the prediction decoding method is performed simply based on the prediction coding information, regardless of whether an image to be decoded is a base view image or a non-base view image.

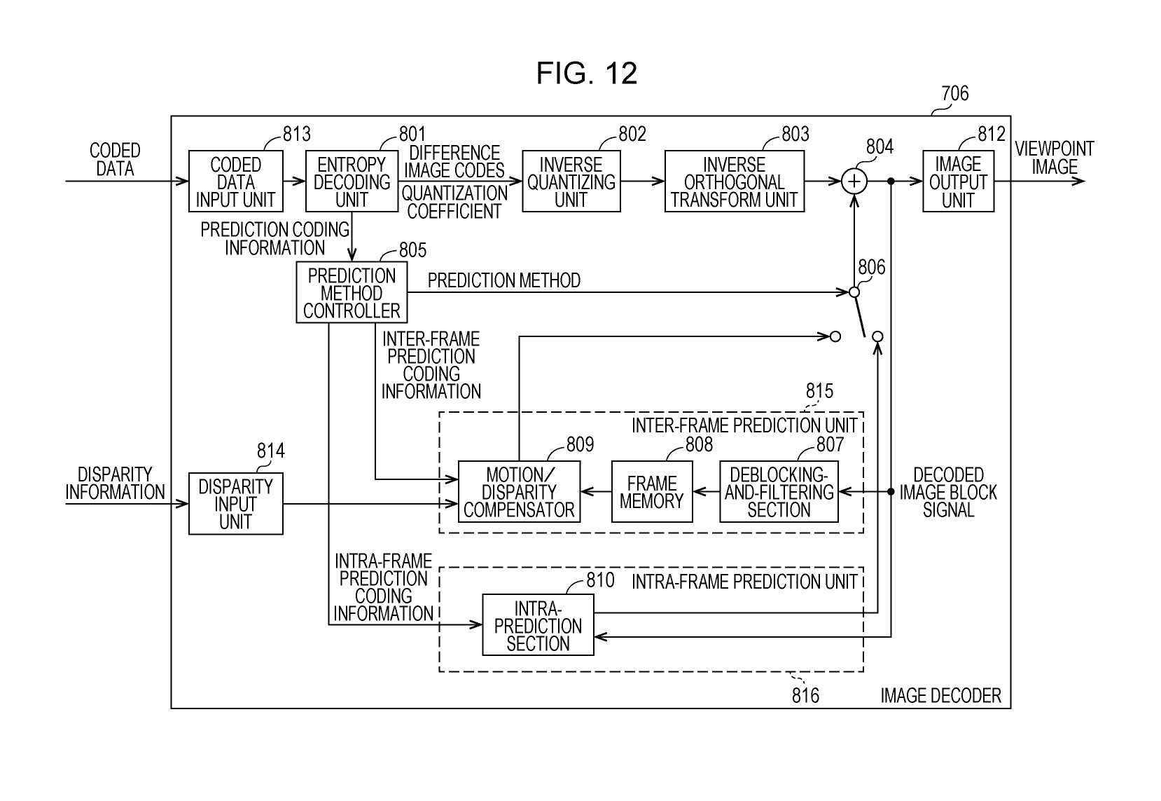

The image decoder 706 will be described below with reference to FIG. 12.

FIG. 12 is a schematic block diagram illustrating the functional configuration of the image decoder 706.

The image decoder 706 includes a coded data input unit 813, an entropy decoding unit 801, an inverse quantizing unit 802, an inverse orthogonal transform unit 803, an adder 804, a prediction method controller 805, a selector 806, a deblocking-and-filtering section 807, a frame memory 808, a motion/disparity compensator 809, an intra-prediction section 810, an image output unit 812, and a disparity input unit 814. For representation, an intra-frame prediction unit 816 and an inter-frame prediction unit 815 are indicated by the broken lines. The intra-frame prediction unit 816 includes the intra-prediction section 810, and the inter-frame prediction unit 815 includes the deblocking-and-filtering section 807, the frame memory 808, and the motion/disparity compensator 809.

When the operation of the image decoder 706 has been discussed with reference to FIG. 11, decoding of a base view and decoding of non-base views other than the base view have been explicitly separated, and it has been assumed that the base view decoding is performed by the base-view decoding processor 702, while the non-base view decoding is performed by the non-base-view decoding processor 705. In practice, however, there are many processing operations in common to be performed both by the base-view decoding processor 702 and the non-base-view decoding processor 705. Accordingly, an integrated mode of base-view decoding processing and non-base-view decoding processing will be described below. More specifically, the above-described intra-view prediction decoding method performed by the base-view decoding processor 702 is a combination of processing performed by the intra-frame prediction unit 816 shown in FIG. 12 and processing for referring to an image of the same viewpoint (motion compensation), which is part of processing performed by the inter-frame prediction unit 815. The above-described inter-view prediction decoding method performed by the non-base-view decoding processor 705 is a combination of processing performed by the intra-frame prediction unit 816 and processing for referring to an image of the same viewpoint (motion compensation) and processing for referring to an image of a different viewpoint (disparity compensation) performed by the inter-frame prediction unit 815. Concerning the processing for referring to an image of the same viewpoint as that of an image to be processed (motion compensation) and the processing for referring to a different viewpoint (disparity compensation) performed by the inter-frame prediction unit 815, the only difference is images which are referred to when performing decoding, and by using ID information (reference view number and reference frame number) indicating a reference image, the two processing operations can be integrated into the same operation. Additionally, processing for reconstructing an image by adding a residual component obtained by decoding coded image data to an image predicted by each of the intra-frame prediction unit 816 and the inter-frame prediction unit 815 may also be performed uniquely regardless of whether an image to be decoded is a base view image or a non-base view image. Details will be given later.

The coded data input unit 813 divides coded image data input from the outside (for example, the image coding apparatus 100) of the image decoding apparatus 700 into blocks having a predetermined unit (for example, 16×16 pixels), and outputs a divided image block to the entropy decoding unit 801. The coded data input unit 813 repeatedly outputs a divided image block by sequentially changing the block positions until all of blocks within an image frame have been processed and until the entire input coded data has been processed.

The entropy decoding unit 801 performs entropy decoding, which is processing (for example, variable-length decoding) reverse to the coding method (for example, variable-length coding) performed by the entropy coding unit 305, on the coded data input from the coded data input unit 813, thereby extracting difference image codes, a quantization coefficient, and prediction coding information. The entropy decoding unit 801 outputs the difference image codes and the quantization coefficient to the inverse quantizing unit 802 and outputs the prediction coding information to the prediction method controller 805.

The inverse quantizing unit 802 inverse-quantizes the difference image codes input from the entropy decoding unit 801 by using the quantization coefficient so as to generate a decoded frequency domain signal. The inverse quantizing unit 802 outputs the decoded frequency domain signal to the inverse orthogonal transform unit 803.

The inverse orthogonal transform unit 803 performs, for example, inverse DCT, on the input decoded frequency domain signal so as to generate a decoded difference image block signal, which is a spatial domain signal. The inverse orthogonal transform unit 803 may utilize a technique (for example, IFFT (Inverse Fast Fourier Transform)) other than inverse DCT as long as it can generate a spatial domain signal on the basis of the decoded frequency domain signal. The inverse orthogonal transform unit 803 outputs the generated decoded difference image block signal to the adder 804.

The prediction method controller 805 extracts a prediction method used for each block in the image coding apparatus 100 from the prediction coding information input from the entropy decoding unit 801. The prediction method is based on intra-frame prediction or inter-frame prediction. The prediction method controller 805 outputs information concerning the extracted prediction method to the selector 806. The prediction method controller 805 also extracts coding information from the prediction coding information input from the entropy decoding unit 801, and outputs the coding information to the processor corresponding to the extracted prediction method. If the prediction method is based on intra-frame prediction, the prediction method controller 805 outputs coding information to the intra-frame prediction unit 816 as the intra-frame prediction coding information. If the prediction method is based on inter-frame prediction, the prediction method controller 805 outputs coding information to the inter-frame prediction unit 815 as the inter-frame prediction coding information.

In accordance with the prediction method input from the prediction method controller 805, the selector 806 selects the intra-frame prediction image block signal input from the intra-frame prediction unit 816 or the inter-frame prediction image block signal input from the inter-frame prediction unit 815. If the prediction method is based on intra-frame prediction, the selector 806 selects the intra-frame prediction image block signal. If the prediction method is based on inter-frame prediction, the selector 806 selects the inter-frame prediction image block signal. The selector 806 outputs the selected prediction image block signal to the adder 804.

The adder 804 adds the prediction image block signal input from the selector 806 to the decoded difference image block signal input from the inverse orthogonal transform unit 803 so as to generate a decoded image block signal. The adder 804 outputs the decoded image block signal to the intra-frame prediction unit 816, the inter-frame prediction unit 815, and the image output unit 812.

The image output unit 812 receives the decoded image block signal from the adder 804, and temporarily stores the decoded image block signal as part of an image in a frame memory (not shown). The image output unit 812 rearranges the frames in the display order, and when all the viewpoint images have been processed, the image output unit 812 outputs them to the outside of the image decoding apparatus 700.

The intra-frame prediction unit 816 and the inter-frame prediction unit 815 will now be described below.

The intra-frame prediction unit 816 will first be discussed below.

The intra-prediction section 810 of the intra-frame prediction unit 816 receives a decoded image block signal from the adder 804 and intra-frame prediction coding information from the prediction method controller 805. The intra-prediction section 810 reproduces intra-frame prediction employed when coding was performed, from the intra-frame prediction coding information. Intra-frame prediction can be performed in accordance with the above-described known method. The intra-prediction section 810 outputs a generated prediction image to the selector 806 as an intra-frame prediction image block signal.

Next, details of the inter-frame prediction unit 815 will be discussed below.

The deblocking-and-filtering section 807 performs the same processing as FIR filtering performed by the deblocking-and-filtering section 311 on a decoded image block signal input from the adder 804, and outputs the processing results (corrected block signal) to the frame memory 808.

Upon receiving the corrected block signal from the deblocking-and-filtering section 807, the frame memory 808 retains the corrected block signal as part of an image, together with information for identifying a viewpoint number and a frame number. In the frame memory 808, a memory manager (not shown) manages the types of pictures or the image order, and the frame memory 808 stores or discards images in response to an instruction of the memory manager. The management of images may also be performed by utilizing an image management technique in MVC, which is a known method.

The motion/disparity compensator 809 receives the inter-frame prediction coding information from the prediction method controller 805, and extracts reference image information (reference view image number and reference frame number) and a difference vector (difference vector between a motion/disparity vector and a prediction vector). The motion/disparity compensator 809 generates a prediction vector by using a disparity vector, which is disparity information input from the disparity input unit 814, in accordance with same method as the prediction vector generating method performed in the above-described motion/disparity compensator 313. That is, concerning a viewpoint image to be decoded, the motion/disparity compensator 809 generates a prediction vector for a different viewpoint image (that is, a viewpoint image different from the viewpoint image to be coded) on the basis of disparity information. The prediction vector generated by the motion/disparity compensator 809 is a prediction vector to be utilized for decoding an image to be decoded (block to be decoded), and a destination (block) pointed by this prediction vector is a block contained in the different viewpoint image (block which has been specified in block matching).

The motion/disparity compensator 809 adds a difference vector to the calculated prediction vector so as to reconstruct a motion/disparity vector. The motion/disparity compensator 809 extracts a target image block signal (prediction image block signal) from images stored in the frame memory 808, on the basis of the reference image information and the motion/disparity vector. The motion/disparity compensator 809 outputs the extracted image block signal to the selector 806 as an inter-frame prediction image block signal.

In the prediction vector generating method performed by the motion/disparity compensator 809, as discussed above, it is sufficient that, among surrounding blocks adjacent to a block to be decoded which will be utilized for generating a prediction vector, information based on disparity information is applied only to blocks from which it is not possible to obtain information required for generating a prediction vector. However, it is possible to apply information based on disparity information also to blocks from which required information can be obtained. That is, in the prediction vector generating method, regardless of whether or not an adjacent block is a block from which required information can be obtained, information based on disparity information concerning a block to be decoded may be utilized.

In generating a prediction vector, it is possible to determine which disparity information in surrounding blocks adjacent to a block to be decoded will be utilized (that is, the range of blocks will be utilized for generating a prediction vector) by referring to prediction range instruction information separately transmitted from the image coding apparatus 100. That is, adjacent blocks to be utilized for generating a prediction vector may be determined in response to an instruction indicated in this prediction range instruction information. The prediction range instruction information may be included in the prediction coding information, in which case, the coded data input unit 813 may receive the prediction coding information, and the entropy decoding unit 801 may decode and extract the prediction range instruction information. Alternatively, if the range of blocks to be utilized for generating a prediction vector is determined as the image coding/decoding standards, the image decoding apparatus 700 may determine the range of blocks in accordance with the standards in advance.

### <Flowchart of Image Decoding Apparatus 700>

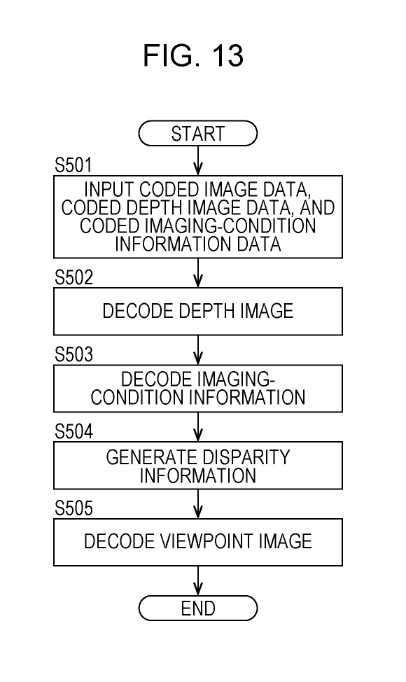

A description will be given below of image decoding processing performed by the image decoding apparatus 700 according to this embodiment. FIG. 13 is a flowchart illustrating image decoding processing performed by the image decoding apparatus 700. The image decoding processing will be discussed with reference to FIG. 11.

In step S501, the image decoding apparatus 700 receives a coded stream from the outside (for example, the image coding apparatus 100) of the image decoding apparatus 700, and separates and extracts coded image data, corresponding coded depth image data and corresponding coded imaging-condition information data by a code separator (not shown). Then, the process proceeds to step S502.

In step S502, the depth image decoder 703 decodes the coded depth image data separated and extracted in step S501, and outputs the results to the disparity information generator 704 and the outside of the image decoding apparatus 700. The process then proceeds to step S503.

In step S503, the imaging-condition information decoder 701 decodes the coded imaging-condition information data separated and extracted in step S501, and outputs the results to the disparity information generator 704 and the outside of the image decoding apparatus 700. The process then proceeds to step S504.

In step S504, the disparity information generator 704 receives the imaging-condition information decoded by the imaging-condition information decoder 701 and the depth image decoded by the depth image decoder 703 and generates disparity information. The disparity information generator 704 outputs the results to the image decoder 706. The process then proceeds to step S505.

In step S505, the image decoder 706 receives the coded image data separated and extracted in step S501 and disparity information from the disparity information generator 704, and decodes the image. The image decoder 706 then outputs the results to the outside of the image decoding apparatus 700.

Disparity information generating processing performed in step S504 is the same as that in step S103, that is, processing in steps S201 through S205.

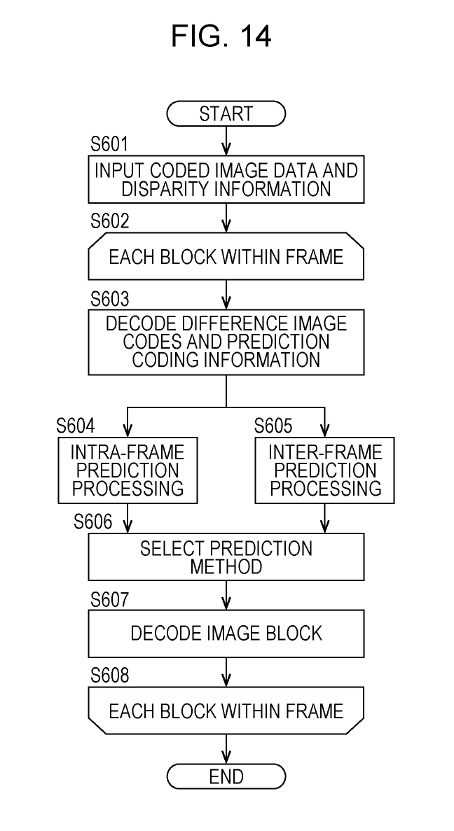

Then, the decoding of a viewpoint image performed in step S505 will be discussed below with reference to FIGS. 14 and 12.

In step S601, the image decoder 706 receives coded image data and corresponding disparity information from the outside of the image decoder 706. The process then proceeds to step S602.

In step S602, the coded data input unit 813 divides coded data input from the outside of the image decoder 706 into processing blocks having a predetermined size (for example, 16×16 pixels in the vertical direction and in the horizontal direction), and outputs a divided block to the entropy decoding unit 801. The disparity input unit 814 receives disparity information, which synchronizes with coded data input into the coded data input unit 813, from the disparity information generator 704, which is disposed outside of the image decoder 706. The disparity input unit 814 then divides disparity information into blocks having a processing unit, which is similar to that of the coded data input unit 813, and outputs a divided block to the inter-frame prediction unit 815.

The image decoder 706 repeats steps S602 through S608 for each of the image blocks within a frame.

In step S603, the entropy decoding unit 801 performs entropy decoding on the coded image data input from the coded data input unit so as to generate difference image codes, a quantization coefficient, and prediction coding information. The entropy decoding unit 801 outputs the difference image codes and the quantization coefficient to the inverse quantizing unit 802 and outputs the prediction coding information to the prediction method controller 805. The prediction method controller 805 receives the prediction coding information from the entropy decoding unit 801 and extracts information concerning the prediction method and coding information corresponding to the prediction method. If the prediction method is based on intra-frame prediction, the prediction method controller 805 outputs the coding information to the intra-frame prediction unit 816 as intra-frame prediction coding information. If the prediction method is based on inter-frame prediction, the prediction method controller 805 outputs the coding information to the inter-frame prediction unit 815 as inter-frame prediction coding information. The process then proceeds to steps S604 and S605.

In step S604, the intra-prediction section 810 of the intra-frame prediction unit 816 receives the intra-frame prediction coding information from the prediction method controller 805 and a decoded image block signal from the adder 308, and performs intra-frame prediction. The intra-prediction section 810 outputs a generated intra-frame prediction image block signal to the selector 806. When processing in step S604 is performed for the first time, if the adder 804 has not finished processing, a reset image block signal (image block signal having all pixel values of 0) is input. The process then proceeds to step S606.

In step S605, the inter-frame prediction unit 815 performs inter-frame prediction on the basis of the inter-frame prediction coding information input from the prediction method controller 805, the decoded image block signal input from the adder 804, and disparity information (that is, a disparity vector) input from the disparity input unit 814. The inter-frame prediction unit 815 outputs a generated inter-frame prediction image block signal to the selector 806. Inter-frame prediction processing will be discussed later. When processing in step S605 is performed for the first time, if the adder 804 has not finished processing, a reset image block signal (image block signal having all pixel values of 0) is input. The process then proceeds to step S606.

In step S606, upon receiving information concerning the prediction method output from the prediction method controller 805, the selector 806 selects the intra-frame prediction image block signal input from the intra-frame prediction unit 816 or the inter-frame prediction image block signal input from the inter-frame prediction unit 815, and outputs the selected prediction image block signal to the adder 804. The process then proceeds to step S607.

In step S607, the inverse quantizing unit 802 performs processing reverse to quantizing processing performed by the quantizing unit 304 of the image coder 106 on the difference image codes input from the entropy decoding unit 801. The inverse quantizing unit 802 outputs a generated decoded frequency domain signal to the inverse orthogonal transform unit 803. Upon receiving the decoded frequency domain signal subjected to inverse quantization from the inverse quantizing unit 802, the inverse orthogonal transform unit 803 performs processing reverse to orthogonal transform processing performed by the orthogonal transform unit 303 of the image coder 106 so as to decode a difference image (decoded difference image block signal). The inverse orthogonal transform unit 803 outputs the decoded difference image block signal to the adder 804. The adder 804 adds the prediction image block signal input from the selector 806 to the decoded difference image block signal input from the inverse orthogonal transform unit 803 so as to generate a decoded image block signal. The adder 804 then outputs the decoded image block signal to the image output unit 812, the intra-frame prediction unit 816, and the inter-frame prediction unit 815. The process then proceeds to step S608.

In step S608, the image output unit 812 disposes the decoded image block signal input from the adder 804 at a corresponding position of the image, thereby generating an output image. If not all the blocks within the frame have been subjected to steps S602 through S608, the block to be processed is changed, and then, the process returns to step S602.

The image output unit 812 rearranges the images in the display order, and outputs multiview images within the same frame together to the outside of the image decoding apparatus 700.

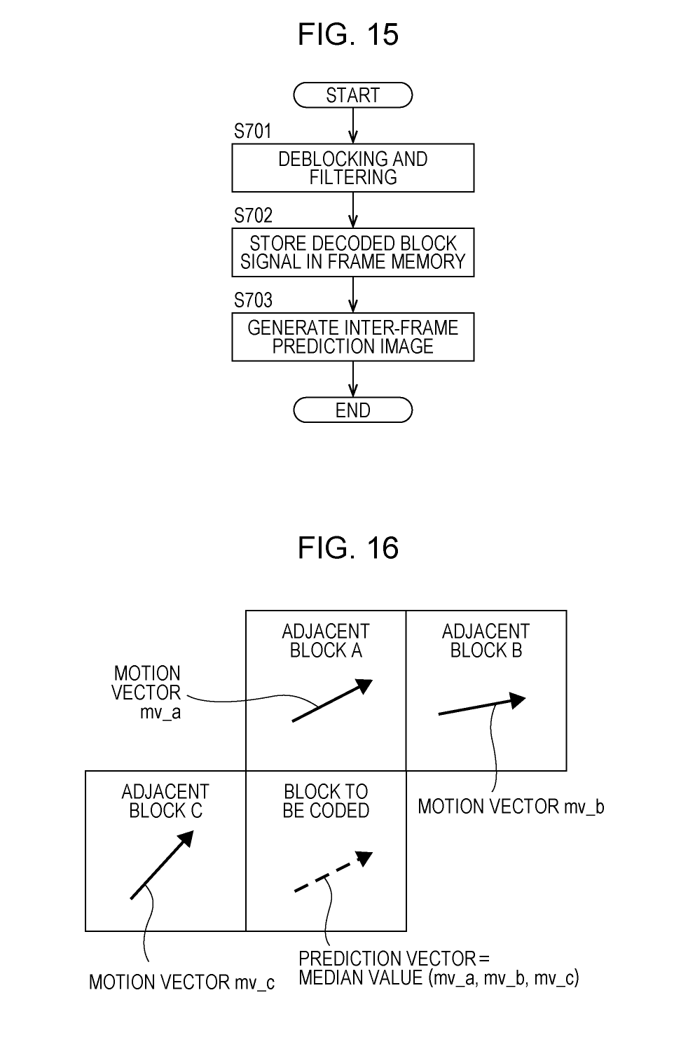

The processing flow of the inter-frame prediction unit 815 will be described below with reference to FIGS. 15 and 12.

In step S701, upon receiving a decoded image block signal from the adder 804, which is disposed outside of the inter-frame prediction unit 815, the deblocking-and-filtering section 807 performs FIR filtering processing, which has been performed during coding. The deblocking-and-filtering section 807 outputs a corrected block signal subjected to filtering processing to the frame memory 808. The process then proceeds to step S702.

In step S702, upon receiving the corrected block signal from the deblocking-and-filtering section 807, the frame memory 808 retains the corrected block signal as part of an image, together with information for identifying a viewpoint number and a frame number. The process then proceeds to step S703.

In step S703, upon receiving the inter-frame prediction coding information from the prediction method controller 805, the motion/disparity compensator 809 extracts reference image information (reference view image number and frame number) and a difference vector (difference vector between a motion/disparity vector and a prediction vector) from the inter-frame prediction coding information. The motion/disparity compensator 809 generates a prediction vector by using a disparity vector, which is disparity information input from the disparity input unit 814, in accordance with the same method as the prediction vector generating method performed by the above-described motion/disparity compensator 313. The motion/disparity compensator 809 adds the difference vector to the calculated prediction vector so as to generate a motion/disparity vector. The motion/disparity compensator 809 extracts a corresponding image block signal (prediction image block signal) from images stored in the frame memory 808, on the basis of the reference image information and the motion/disparity vector. The motion/disparity compensator 809 outputs the extracted image block signal to the selector 806 as an inter-frame prediction image block signal. Then, inter-frame prediction processing has been terminated.

In this manner, according to this embodiment, the image decoding apparatus 700 is capable of performing disparity-compensated prediction by generating a prediction vector by using a depth image corresponding to an image to be decoded. More specifically, the image decoding apparatus 700 is capable of performing disparity-compensated prediction by utilizing a prediction vector based on disparity information (that is, a disparity vector) calculated from this depth image. That is, according to this embodiment, it is possible to decode data which has been coded with improved coding efficiency by enhancing the precision of prediction vectors, as has been performed in the image coding apparatus 100 shown in FIG. 1.

### Third Embodiment

### Software and Methods

Some components of the image coding apparatus 100 and the image decoding apparatus 700 of the above-described embodiments, for example, part of the depth image coder 103, the disparity information generator 104, the imaging-condition information coder 101, some components of the image coder 106, that is, the subtractor 302, the orthogonal transform unit 303, the quantizing unit 304, the entropy coding unit 305, the inverse quantizing unit 306, the inverse orthogonal transform unit 307, the adder 308, the prediction method controller 309, the selector 310, the deblocking-and-filtering section 311, the motion/disparity compensator 313, the motion/disparity vector detector 314, and the intra-prediction section 315, part of the depth image decoder 703, the disparity information generator 704, the imaging-condition information decoder 701, and some components of the image decoder 706, that is, the entropy decoding unit 801, the inverse quantizing unit 802, the inverse orthogonal transform unit 803, the adder 804, the prediction method controller 805, the selector 806, the deblocking-and-filtering section 807, the motion/disparity compensator 809, and the intra-prediction section 810 may be implemented by using a computer.

In this case, a program (image coding program and/or image decoding program) for implementing the control functions may be recorded on a computer-readable recording medium, and the program recorded on this recording medium may be read into a computer system and executed. The term “computer system” is a computer system integrated in the image coding apparatus 100 or the image decoding apparatus 700, and includes an OS or hardware, such as peripheral devices. The term “computer-readable recording medium” is a portable medium, such as a flexible disk, a magneto-optical disc, a ROM, and a CD-ROM, or a storage device, such as a hard disk built in the computer system. The term “computer-readable recording medium” may include a medium that dynamically stores the program for a short period of time, such as a communication line used for transmitting the program via a network, such as the Internet, or a communication circuit, such as a telephone line, and may also include a device that stores the program for a certain period of time, such as a non-volatile memory within the computer system, which serves as a server or a client when the program is transmitted through a network or a communication circuit. The above-described program may be used for implementing some of the above-described functions, or may be used for implementing the above-described functions, together with a program which has already been recorded on the computer system. This program may be distributed via broadcasting waves, instead of being distributed via a portable recording medium or a network.

This image coding program is a program for causing a computer to execute image coding processing for coding a plurality of viewpoint images captured from different viewpoints. The program causes the computer to execute: a step of coding information indicating a positional relationship between a subject and cameras which are set for capturing the plurality of viewpoint images; a step of generating disparity information on the basis of the information and at least one of depth images corresponding to the plurality of viewpoint images; and a step of generating, concerning a viewpoint image to be coded, a prediction vector for a viewpoint image different from the viewpoint image to be coded, on the basis of the disparity information, and coding the viewpoint image to be coded by using the prediction vector in accordance with an inter-view prediction coding method. Other examples of applications are the same as those discussed in the image coding apparatus.

The above-described image decoding program is a program for causing a computer to execute image decoding processing for decoding a plurality of viewpoint images captured from different viewpoints. The program causes the computer to execute: a step of decoding information indicating a positional relationship between a subject and cameras which have been set for capturing the plurality of viewpoint images; a step of generating disparity information on the basis of the information and at least one of depth images corresponding to the plurality of viewpoint images; and a step of generating, concerning a viewpoint image to be decoded, a prediction vector for a viewpoint image different from the viewpoint image to be decoded, on the basis of the disparity information, and decoding the viewpoint image to be decoded by using the prediction vector in accordance with an inter-view prediction decoding method. Other examples of applications are the same as those discussed in the image decoding apparatus. This image decoding program can be implemented as part of multiview image playback software.

Some or all of the components of the image coding apparatus 100 and the image decoding apparatus 700 of the above-described embodiments may be implemented in the form of an integrated circuit, such as an LSI (Large Scale Integration), or an IC (Integrated Circuit) chip set. The functional blocks of the image coding apparatus 100 and the image decoding apparatus 700 may be individually formed into processors, or all or some of the functional blocks may be integrated into a processor. In this case, the functional blocks of the image coding apparatus 100 and the image decoding apparatus 700 do not have to be integrated into an LSI, but they may be implemented by using a dedicated circuit or a general-purpose processor. Moreover, due to the progress of semiconductor technologies, if a circuit integration technology which replaces an LSI technology is developed, an integrated circuit formed by such a technology may be used.

The present invention may be implemented in the form of an image coding method and an image decoding method, as illustrated in the flows of control in the image coding apparatus and the image decoding apparatus by way of example and in the processing of steps of the image coding program and the image decoding program described above.

This image coding method is a method for coding a plurality of viewpoint images captured from different viewpoints. The image coding method includes: a step of coding, by an information coder, information indicating a positional relationship between a subject and cameras which are set for capturing the plurality of viewpoint images; a step of generating, by a disparity information generator, disparity information on the basis of the information and at least one of depth images corresponding to the plurality of viewpoint images; and a step of generating, by an image coder, concerning a viewpoint image to be coded, a prediction vector for a viewpoint image different from the viewpoint image to be coded, on the basis of the disparity information, and coding the viewpoint image to be coded by using the prediction vector in accordance with an inter-view prediction coding method. Other examples of applications are the same as those discussed in the image coding apparatus.

The above-described image decoding method is a method for decoding a plurality of viewpoint images captured from different viewpoints. The image decoding method includes: a step of decoding, by an information decoder, information indicating a positional relationship between a subject and cameras which have been set for capturing the plurality of viewpoint images; a step of generating, by a disparity information generator, disparity information on the basis of the information and at least one of depth images corresponding to the plurality of viewpoint images; and a step of generating, by an image decoder, concerning a viewpoint image to be decoded, a prediction vector for a viewpoint image different from the viewpoint image to be decoded, on the basis of the disparity information, and decoding the viewpoint image to be decoded by using the prediction vector in accordance with an inter-view prediction decoding method. Other examples of applications are the same as those discussed in the image decoding apparatus.

### REFERENCE SIGNS LIST

100 image coding apparatus
101 imaging-condition information coder
102 base-view coding processor
103 image coder
104 disparity information generator
105 non-base-view coding processor
106 image coder
201 block divider
202 representative-depth-value determining unit
203 disparity calculator
204 distance information extracting unit
301 image input unit
302 subtractor
303 orthogonal transform unit
304 quantizing unit
305 entropy coding unit
306 inverse quantizing unit
307 inverse orthogonal transform unit
308 adder
309 prediction method controller
310 selector
311 deblocking-and-filtering section
312 frame memory
313 motion/disparity compensator
314 motion/disparity vector detector
315 intra-prediction section
316 disparity input unit
317 intra-frame prediction unit
318 inter-frame prediction unit
700 image decoding apparatus
701 imaging-condition information decoder
702 base-view decoding processor
703 image decoder
704 disparity information generator
705 non-base-view decoding processor
706 image decoder
801 entropy decoding unit
802 inverse quantizing unit
803 inverse orthogonal transform unit
804 adder
805 prediction method controller
806 selector
807 deblocking-and-filtering section
808 frame memory
809 motion/disparity compensator
810 intra-prediction section
812 image output unit
813 coded data input unit
814 disparity input unit
815 inter-frame prediction unit
816 intra-frame prediction unit

1-18. (canceled)

19. An image coding apparatus for coding a plurality of viewpoint images captured from different viewpoints, comprising:
an information coder that codes information corresponding to parameters for calculating disparity values of the plurality of viewpoint images;
a disparity information generator that generates disparity information on the basis of the information and at least one of depth images corresponding to the plurality of viewpoint images; and
an image coder that generates, concerning a viewpoint image to be coded, a prediction vector for a viewpoint image different from the viewpoint image to be coded, on the basis of a disparity vector of a surrounding block adjacent to a block to be coded, and that codes the viewpoint image to be coded by using the prediction vector in accordance with an inter-view prediction coding method,
wherein, on the basis of the disparity information, the image coder determines, among surrounding blocks, a disparity vector for a surrounding block from which it is not possible to obtain information required for generating a prediction vector of the block to be coded.

20. The image coding apparatus according to claim 19, further comprising:
a depth image coder that codes the depth image.

21. An image decoding apparatus for decoding a plurality of viewpoint images captured from different viewpoints, comprising:
an information decoder that decodes information corresponding to parameters for calculating disparity values of the plurality of viewpoint images;
a disparity information generator that generates disparity information on the basis of the information and at least one of depth images corresponding to the plurality of viewpoint images; and
an image decoder that generates, concerning a viewpoint image to be decoded, a prediction vector for a viewpoint image different from the viewpoint image to be decoded, on the basis of a disparity vector of a surrounding block adjacent to a block to be decoded, and that decodes the viewpoint image to be decoded by using the prediction vector in accordance with an inter-view prediction decoding method,
wherein, on the basis of the disparity information, the image decoder determines, among surrounding blocks, a disparity vector for a surrounding block from which it is not possible to obtain information required for generating a prediction vector of the block to be decoded.

22. The image decoding apparatus according to claim 21, wherein:
the depth image is coded; and
the image decoding apparatus further comprises a depth image decoder that decodes the depth image.
